(19) United States
(12) Patent Application Publication
(10) Pub. No.: US 2026/0362576 A1
(43) Pub. Date: Nov. 12, 2026

(54) LIGHT EFFECT EDITING AND PLAYBACK METHOD AND APPARATUS FOR LIGHT-EMITTING DEVICE

(71) Applicant: Shenzhen Intellirocks Tech. Co., Ltd., Shenzhen (CN)

(72) Inventors: Kewei LIANG, Shenzhen (CN); Shiqi ZHOU, Shenzhen (CN); Wenlong WU, Shenzhen (CN)

(21) Appl. No.: 19/722,937

(22) Filed: Jun. 28, 2026

Related U.S. Application Data
(63) Continuation of application No. PCT/CN2025/079257, filed on Feb. 26, 2025.

(30) Foreign Application Priority Data
Feb. 26, 2024 (CN) 202410205803.4
Feb. 26, 2024 (CN) 202410205826.5

(51) Int. Cl. H05B 47/175

(52) U.S. Cl. CPC H05B 47/1985

(57) ABSTRACT

The present disclosure relates to a light effect editing and playback method and apparatus for a light-emitting device. The method comprises: acquiring a position information flow corresponding to light-emitting units in a light-emitting strip lamp, wherein the position information flow comprises position distribution information corresponding to the light-emitting units; expanding the position distribution information of the light-emitting units in a preset coordinate system to obtain a strip lamp projection map; using region tolerance windows to divide the light-emitting strip lamp in the strip lamp projection map into a plurality of light-emitting unit sets; and by using each display control window as a batch control unit, generating light-emitting control data for a light-emitting unit set of each display control window corresponding to a target lamp effect, and on the basis of the light-emitting control data, controlling the light-emitting strip lamp to play the target lamp effect.

### CROSS-REFERENCE TO RELATED APPLICATIONS

This application is a continuation of International Application No. PCT/CN2025/079257, filed on Feb. 26, 2025, which claims priority to Chinese Patent Application No. 202410205826.5, filed on Feb. 26, 2024, and to Chinese Patent Application No. 202410205803.4, filed on Feb. 26, 2024, all of which are hereby incorporated by reference in their entirety.

### TECHNICAL FIELD

The present disclosure relates to the field of lighting control, and in particular, to a lighting effect editing and playback method and apparatus for a light-emitting device.

### BACKGROUND

In an ambient light device, a light-emitting strip is adopted as the light strip body responsible for light emission and atmosphere rendering. Since the light-emitting strip possesses flexibility, it can be bent and shaped into various desired shapes. When it is necessary to play a corresponding lighting effect via the light-emitting strip, the lighting effect can provide a color distribution based on materials such as reference images; the color distribution is projected onto the light-emitting strip, and the corresponding lighting effect is played collaboratively by each of the light-emitting units in the light-emitting strip to display the corresponding color distribution, thereby achieving the effect of light atmosphere rendering.

To support the projection of the color distribution onto the light-emitting strip, it is necessary to know the position distribution of the light-emitting units in the light-emitting strip on a pattern plane formed by the light-emitting strip. When the color distribution needs to be projected, the projection can be realized by referring to this position distribution.

### SUMMARY

An objective of the present disclosure is to provide a lighting effect editing and playback method and apparatus for a light-emitting device.

According to an aspect of the present disclosure, a lighting effect projection playback method is provided. The method includes:

acquiring a position information stream corresponding to light-emitting units in a light-emitting strip, the position information stream including position distribution information corresponding to each of the light-emitting units in the light-emitting strip;

unfolding to obtain a light strip projection map in a preset coordinate system based on the position distribution information of each of the light-emitting units, so as to reconstruct the light-emitting strip and pattern data of each of the light-emitting units therein in the light strip projection map;

dividing the light-emitting strip in the light strip projection map into a plurality of light-emitting unit sets by using a region tolerance window to correspondingly form a plurality of display control windows; and

generating, with each display control window as a batch control unit, light-emitting control data corresponding to a target lighting effect for the light-emitting unit set of each display control window, and controlling the light-emitting strip to play the target lighting effect based on the light-emitting control data.

According to an aspect of the present disclosure, a method for editing a lighting effect light-emitting region is provided. The method includes:

determining a shape path of a light-emitting strip and a plurality of light positions on the shape path based on a light strip image to construct a corresponding light strip model and display the light strip model on an interface canvas;

determining, in response to a light position graffiti event, the light positions in the light strip model where graffiti is performed as graffiti light positions, and generating corresponding graffiti light position information;

determining, in response to a starting point positioning event, a position of a starting point on the interface canvas as a starting point relative position, and generating corresponding lighting effect lighting information, where the starting point is configured to position a special effect starting point of a lighting coverage region, and the lighting coverage region is configured to activate a light effect of the graffiti light positions; and

generating, in response to a lighting effect application event, a lighting effect configuration with the graffiti light position information and the lighting effect lighting information, and pushing the lighting effect configuration to a light-emitting device of the light-emitting strip.

According to another aspect of the present disclosure, an ambient light device is provided. The ambient light device includes a controller and at least one light-emitting strip, where the controller is configured to perform at least one of: a lighting effect projection playback method and a method for editing a lighting effect light-emitting region. The lighting effect projection playback method comprises: acquiring a position information stream corresponding to light-emitting units in a light-emitting strip, the position information stream comprising position distribution information corresponding to each of the light-emitting units in the light-emitting strip; unfolding to obtain a light strip projection map in a preset coordinate system based on the position distribution information of each of the light-emitting units, so as to reconstruct the light-emitting strip and pattern data of each of the light-emitting units therein in the light strip projection map; dividing the light-emitting strip in the light strip projection map into a plurality of light-emitting unit sets by using a region tolerance window to correspondingly form a plurality of display control windows; and generating, with each display control window as a batch control unit, light-emitting control data corresponding to a target lighting effect for the light-emitting unit set of each display control window, and controlling the light-emitting strip to play the target lighting effect based on the light-emitting control data. The method for editing a lighting effect light-emitting region comprises: determining a shape path of a light-emitting strip and a plurality of light positions on the shape path based on a light strip image to construct a corresponding light strip model and display the light strip model on an interface canvas; determining, in response to a light position graffiti event, the light positions in the light strip model where graffiti is performed as graffiti light positions, and generating corresponding graffiti light position information; determining, in response to a starting point positioning event, a position of a starting point on the interface canvas as a starting point relative position, and generating corresponding lighting effect lighting information, wherein the starting point is configured to position a special effect starting point of a lighting coverage region, and the lighting coverage region is configured to activate a light effect of the graffiti light positions; and generating, in response to a lighting effect application event, a lighting effect configuration with the graffiti light position information and the lighting effect lighting information, and pushing the lighting effect configuration to a light-emitting device of the light-emitting strip.

### BRIEF DESCRIPTION OF THE DRAWINGS

In order to more clearly illustrate the embodiments of the present disclosure or technical solutions in the related art, the drawings used in the description of the embodiments or related art will be briefly described below. It is apparent that other drawings can be derived from these drawings by those of ordinary skill in the art without creative efforts.

FIG. 1 is a schematic diagram of an electrical structure of an exemplary ambient light device according to the present disclosure, where a light-emitting strip of the ambient light device is shaped into a flower to indicate that the light-emitting strip can be shaped into any shape;

FIG. 2 illustrates a logical segmentation relationship of the light-emitting strip in FIG. 1 divided by using a region tolerance window;

FIG. 3 is a schematic flowchart of a lighting effect projection playback method in accordance with some embodiments;

FIG. 4 is a schematic flowchart of determining a display control window by sliding a region tolerance window in accordance with some embodiments;

FIG. 5 is a schematic flowchart of determining a dimension specification of a region tolerance window in accordance with some embodiments;

FIG. 6 is a schematic flowchart of setting a region tolerance window based on a circular ring and determining a display control window based on the region tolerance window in accordance with some embodiments;

FIG. 7 is a schematic flowchart of constructing light-emitting control data corresponding to a display control window in accordance with some embodiments;

FIG. 8 is a schematic flowchart of a method for editing a lighting effect light-emitting region in accordance with some embodiments;

FIGS. 9, 10, and 11 are schematic diagrams of graphical user interfaces of interface canvases in different cases, respectively;

FIGS. 12, 13, 14, and 19 are schematic diagrams of a lighting coverage region during rotation in different cases, respectively;

FIG. 15 is a schematic flowchart of constructing a light strip model based on a light strip image and displaying the light strip model on an interface canvas in accordance with some embodiments;

FIG. 16 is a schematic flowchart of graffiti at a graffiti light position in accordance with some embodiments;

FIG. 17 is a schematic flowchart of adjusting a region included angle and a rotation speed of a lighting coverage region and determining a starting point relative position of a starting point thereof in accordance with some embodiments;

FIG. 18 is a schematic flowchart of a light-emitting device generating a corresponding chasing lighting effect based on a lighting effect configuration in accordance with some embodiments;

FIG. 20 is a schematic flowchart of a light-emitting device generating corresponding chasing lighting effects based on a plurality of sets of lighting effect configurations in accordance with some embodiments.

FIG. 21 is a schematic structural diagram of a computer device in accordance with some embodiments.

### DETAILED DESCRIPTION

It should be understood that the specific embodiments described herein are intended to explain the technical solutions of the present disclosure only, rather than to limit the present disclosure. In order to better understand the technical solutions of the present disclosure, the following will be described in detail with reference to the drawings and specific embodiments.

Referring to FIG. 1, it can be seen from a schematic structural diagram of an ambient light device provided according to one embodiment of the present disclosure that the ambient light device includes a controller 1 and a light strip body 2. The light strip body 2 is electrically connected to the controller 1 to accept the control of a computer program running in the controller 1 to work cooperatively and realize lighting effect playback.

The controller 1 usually includes a control chip, a communication component, and a bus connector. In some embodiments, the controller 1 may further be configured with a power adapter, a control panel, a display screen, and the like as needed.

The power adapter is mainly configured to convert mains electricity into direct current, so as to supply power to the entire ambient light device. The control chip may be implemented using various embedded chips, such as various types of chips including Bluetooth SoC (System on Chip), WiFi SoC, MCU (Micro Controller Unit), DSP (Digital Signal Processing), and the like. The control chip usually includes a central processing unit and a memory; the memory and the central processing unit are respectively configured to store and execute program instructions to realize corresponding functions. The various types of control chips mentioned above may come with a communication component or be additionally configured with a communication component as needed. The communication component may be configured to communicate with an external device; for example, the communication component may communicate with a terminal device such as a personal computer or various smartphones, so that after a user issues various configuration instructions via their terminal device, the control chip of the controller 1 can receive the configuration instructions via the communication component to complete basic configuration, so as to control the light strip body to work. The bus connector is mainly configured to provide power access to the light strip body 2 accessing the bus, and provide a lighting effect playback instruction, and thus provides pins corresponding to a power bus and a signal bus. In this way, when the light strip body 2 needs to access the controller 1, the light strip body only needs to be connected to the bus connector via a corresponding connector of the light strip body 2. The control panel usually provides one or a plurality of keys, which are configured to implement switch control on the controller 1, select various preset lighting effect control modes, and so on. The display screen may be configured to display various control information, so as to cooperate with the keys on the control panel to support the realization of human-machine interaction functions. In some embodiments, the control panel and the display screen may be integrated into the same touch display screen.

The light strip body 2 in the ambient light device is implemented using light-emitting strips, and may include one or more light-emitting strips; since the light-emitting strips possess flexibility, the light-emitting strips can be shaped into a layout of any shape. Each light-emitting strip 21 includes a plurality of light beads 210 connected in series, with each light bead 210 serving as a light-emitting unit; moreover, the number of light beads 210 in each light-emitting strip 21 may be the same, and the light beads are arranged at equal intervals. Working current is transmitted to light beads 210 in the same light-emitting strip 21 by the same set of cables accessing the bus; in terms of electrical connection relationship, the light beads 210 of the same light-emitting strip 21 may be connected in a parallel manner.

The controller 1 in the ambient light device can receive the position distribution information of light-emitting units in the light-emitting strip in the ambient light device from an external terminal device, so as to generate a light strip projection map based on the position distribution information, which is used as pattern data for playing a target lighting effect. When the ambient light device is to play a target lighting effect, the lighting effect description data of the target lighting effect is called first, and the controller 1 thereof needs to determine a plurality of display control windows on the light-emitting strip based on the pattern data corresponding to the light strip body 2 thereof, so as to parse the corresponding lighting effect description data into light-emitting control data corresponding to each display control window. The light-emitting control data is directly used as the light-emitting control data of each light-emitting unit in the display control window; that is, all light-emitting units in the same display control window use the same light-emitting control data, and then the corresponding light-emitting control data is sent with the display control window as a batch control unit. A control chip of each corresponding light-emitting unit in the light-emitting strip controls each light-emitting element therein to emit corresponding colored light based on the light-emitting control data, thereby realizing the playback of the entire target lighting effect under the cooperative action of the colored light emitted by the light-emitting units.

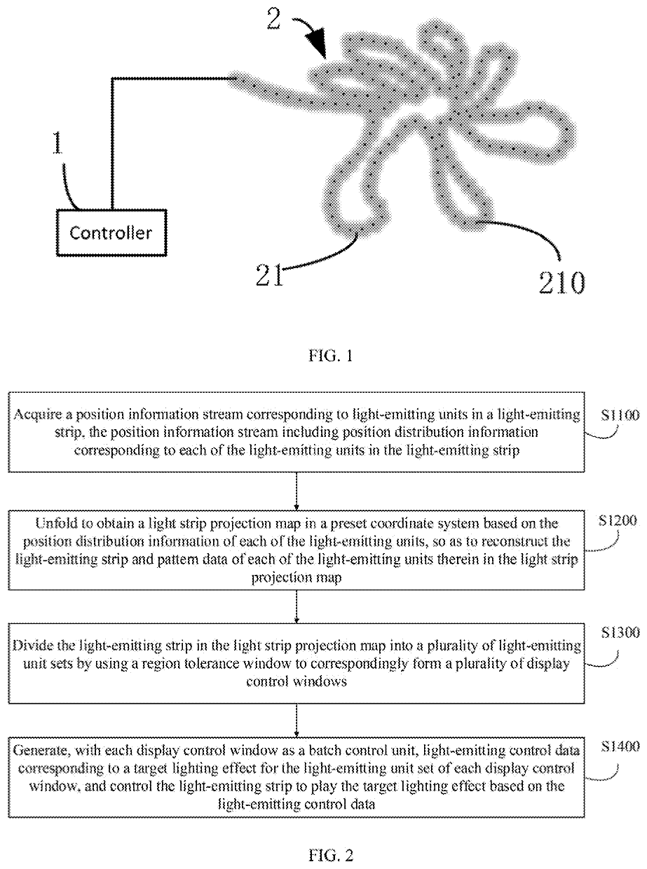

According to the product architecture and working principle of the ambient light device described above, the lighting effect projection playback method of an ambient light device according to the present disclosure can be implemented as a computer program product running in the controller of the ambient light device. Accordingly, referring to FIG. 2, in some embodiments, the lighting effect projection playback method according to the present disclosure includes:

In step S1100, a position information stream corresponding to light-emitting units in a light-emitting strip is acquired, where the position information stream includes position distribution information corresponding to the light-emitting units in the light-emitting strip.

In the present disclosure, by means of a terminal device such as a mobile terminal, a light-emitting strip in an ambient light device is photographed to obtain a light-emitting strip image, a light strip model representing a shape path of the light-emitting strip in the light strip image and each of light positions on the shape path is constructed based on the light strip image, and the light strip model is displayed on an interface canvas; in response to a light position calibration instruction, a light position specified by the instruction is determined as a valid light position; in response to a layout generation instruction, position coordinates of all valid light positions determined in the light strip model with reference to the interface canvas are organized according to an order of all valid lighting effects along the light-emitting strip to form position distribution information. It is not difficult to understand that one valid light position corresponds to one light-emitting unit in the light-emitting strip of the ambient light device. Accordingly, the position distribution information of the light-emitting strip can be quickly generated and sent to the controller according to the present disclosure by the terminal device in the form of a position information stream, so that the data amount is small, and the transmission is fast.

In a more specific embodiment, the mobile terminal may first send a lighting instruction to the light-emitting strip in the ambient light device to control the light-emitting strip in the ambient light device to light up to present a preset light-emitting feature, where the lighting instruction includes light-emitting feature information corresponding to the light-emitting feature; then determine a shape region of the light-emitting strip based on the light strip image photographed in a lit state of the light-emitting strip to define the shape path of the light-emitting strip, and extract a light strip body image within the shape region; further identify salient lighting features carried by the light-emitting feature in the light strip body image, and determine positions where each of the salient lighting features is located as the corresponding light positions; and finally construct the shape path and each of the light positions as a light strip model, and display the light strip model on the interface canvas. It can be seen that with the help of the light-emitting feature, the terminal device can more accurately identify the light positions corresponding to each light-emitting unit in the light-emitting strip.

The position distribution information obtained by the terminal device only includes the position coordinates of the light-emitting units distributed along the light-emitting strip, and the distribution order of the light-emitting units along the light-emitting strip is represented by the sequence of the position coordinates, thereby forming one data stream, that is, the position information stream. The terminal device transmits the position information stream to the controller instead of transmitting the entire image represented by the interface canvas to the controller, thereby achieving a more efficient transmission effect.

After receiving the position information stream sent by the terminal device, the controller according to the present disclosure can perform corresponding parsing on the position information stream, so as to obtain the position distribution information in the position information stream, that is, the position coordinates of the light-emitting units in the light-emitting strip of the ambient light device. Meanwhile, since the position coordinates of the light-emitting units have been sorted in the position distribution information according to the order of the light-emitting units along the light-emitting strip, sequence information corresponding to each of the light-emitting units can also be obtained.

In step S1200, a light strip projection map is obtained by unfolding in a preset coordinate system based on the position distribution information of each of the light-emitting units, so as to reconstruct the light-emitting strip and the pattern data of each of the light-emitting units therein in the light strip projection map.

In order to reproduce the shape of the light-emitting strip in the planar space in the controller, the controller presets a coordinate system, and the coordinate system corresponding to the interface canvas of the terminal device is defined as a two-dimensional rectangular coordinate system. Accordingly, based on the position distribution information of each unit, specifically based on the position coordinates of each of the light-emitting units in the position distribution information, the light-emitting unit is calibrated into the coordinate system as a corresponding light position in the memory of the controller, and then a light strip projection map described based on the pattern data can be obtained in the memory. Since the position distribution information of each of the light-emitting units also carries the sequence information of each of the light-emitting units, the corresponding light positions in the light strip projection map are marked with the sequence information of each of the light-emitting units, so that more complete pattern data can be obtained, and the light strip projection map can be called based on the pattern data subsequently.

The position distribution information of each of the light-emitting units is unfolded into a light strip projection map, so that the relative position relationship between the light positions in the light-emitting strip can be reproduced, and the planar layout of the light-emitting strips in the physical space can be reproduced, thereby realizing the precise identification of the specific shape of the light-emitting strip. On this basis, the lighting effect mapping is more accurate, which can ensure that the displayed lighting effects are consistent with the expected effects.

In step S1300, the light-emitting strip in the light strip projection map is divided into a plurality of light-emitting unit sets by using a region tolerance window to correspondingly form a plurality of display control windows.

Although the light-emitting units in the light-emitting strip are generally arranged at equal intervals, the light-emitting strip often has a bent or folded shape in actual use. At relatively straight positions, the light-emitting strip appears sparser on the projection plane, while at heavily folded positions, the light-emitting units are generally denser. In order to enable the control of the light-emitting strip to have a more regular and uniform control effect on the projection plane, as shown in FIG. 3, the present disclosure applies a region tolerance window 88 to divide and set the light-emitting units in the light-emitting strip, and takes a plurality of light-emitting units included in each region tolerance window as a light-emitting unit set corresponding to a corresponding display control window. Subsequently, it is convenient to use the display control window as a batch control unit to control all the light-emitting units in the same display control window by using unified light-emitting control data.

As shown in FIG. 3, the region tolerance window 88 according to the present disclosure, which is shown on the projection plane corresponding to the light strip projection map, generally has substantially the same area, or has a proportional area relationship, depending on the specific situation. A plurality of light-emitting units covered by the region tolerance window constitute a light-emitting unit set of the display control window at a corresponding position in the light strip projection map. When the region tolerance windows of the same dimensions appear at different positions in the light strip projection map, the number of light-emitting units covered may be different, and correspondingly, the number of light-emitting units in different display control windows may also be different, while one light-emitting unit only belongs to one display control window. Generally, mapping relationship data is typically constructed between the display control window and its light-emitting unit set for calling purposes.

After the corresponding display control window is determined based on the region tolerance window, a mapping relationship between the display control window and each of the light-emitting units in the corresponding light-emitting unit set thereof may be established. Subsequently, with the display control window as a unit, the light-emitting control data is generated in batches for each of the light-emitting units therein, so as to increase the generation speed of the light-emitting control data. It is not difficult to understand that the mapping relationship between each of the light-emitting units in the light strip projection map and the display control window to which the light-emitting unit belongs is established by calibrating the mapping relationship between the light-emitting unit and the display control window in the memory. Therefore, when the light-emitting control data of the light-emitting units in each display control window needs to be generated based on the light strip projection map, corresponding data calls can be performed with reference to these mapping relationships.

In step S1400, with each of the display control windows as a batch control unit, light-emitting control data corresponding to a target lighting effect for the light-emitting unit set of each display control window is generated, and the light-emitting strip is controlled to play the target lighting effect based on the light-emitting control data.

The target lighting effect to be played in the light-emitting strip of the ambient light device may be provided by the terminal device, or may be called from the memory of the controller, or may be downloaded by the controller from the cloud server.

The target lighting effect is described in the form of lighting effect description data, and the lighting effect description data may be represented in any form such as an image frame or a message body so as to realize the definition of the lighting effect motion process of the target lighting effect. The lighting effect motion process is defined based on the lighting effect description data of the target lighting effect, and the lighting effect motion process can be parsed into light-emitting control data corresponding to each playback frame. Specifically, for each of the display control windows in the light-emitting strip corresponding to each playback frame, the light-emitting units in the light-emitting unit set of the display control window are determined based on the preset mapping relationship data. By uniformly setting the light-emitting control data for these light-emitting units, the light-emitting control data corresponding to each of the light-emitting units in the light-emitting unit set can actually be generated. For each display control window, since the display control window corresponds to a light-emitting unit set, and each light-emitting unit uniformly uses the light-emitting control data as its corresponding light-emitting control data, it is not necessary to generate respective control data for each light-emitting unit, which can improve the efficiency of generating the control data of each of the light-emitting units corresponding to the playback frame.

After generating the light-emitting control data of each of the display control windows corresponding to the playback frame, the controller may send the light-emitting control data to the light-emitting strip according to a certain rule. For example, the light-emitting control data of the corresponding display control window may be sent in each corresponding playback time slot based on the playback time slot corresponding to each piece of light-emitting control data; or all the light-emitting control data corresponding to the entire playback frame may be encoded and packaged, and sent to the light-emitting strip. In the data packet encapsulating the light-emitting control data, the light-emitting control data is generally arranged and set corresponding to the sequence information of each of the light-emitting units in the light-emitting strip, so that each of the light-emitting units in the light-emitting strip can extract light-emitting control data corresponding to its own sequence position from the data packet, and control the light-emitting element therein to emit corresponding light based on the light-emitting control data. The light-emitting units in the light-emitting strip all work according to the same principle, so that the cooperative playback of the same playback frame can be realized. In the same playback frame, different display control windows are controlled to play their corresponding lighting effects in different slots, and/or a plurality of playback frames are successively played, etc., which can further display more complicated animation effects. The specific animation effect is displayed according to the definition of the lighting effect motion process in the target lighting effect.

It can be known from the above embodiments that the present disclosure adapts to the characteristics that the light-emitting strip possesses flexibility and is shapeable. The position information stream corresponding to each of the light-emitting units of the light-emitting strip is acquired in the controller of the ambient light device, the light strip projection map is obtained by unfolding in the preset coordinate system based on the position distribution information of the light-emitting unit represented by the position information stream, and then all the light-emitting units of the light-emitting strip are divided into a plurality of display control windows by applying the preset region tolerance window based on the pattern data of the light strip projection map, so that the planar region occupied by each display control window in the light strip projection map is substantially similar. Then, with the display control window as the batch control unit, the light-emitting control data corresponding to the target lighting effect for each display control window is generated, so that all the light-emitting units in each display control window uniformly apply the light-emitting control data to perform lighting effect playback control on the light-emitting units therein, thereby effectively reducing the system overhead of the controller for generating all the light-emitting control data corresponding to all the light-emitting units of the light-emitting strip. Since the planar region occupied by the display control window is substantially similar, when the target lighting effect is played accordingly, the difference in the density of the light-emitting units in different regions caused by the bending and folding of the light-emitting strip can be effectively balanced, so that unnecessary distortion of the played lighting effect relative to the desired effect can be effectively prevented, and the display of the lighting effects is more accurate, which can improve the user's product experience and make it easier to promote and popularize such ambient light device.

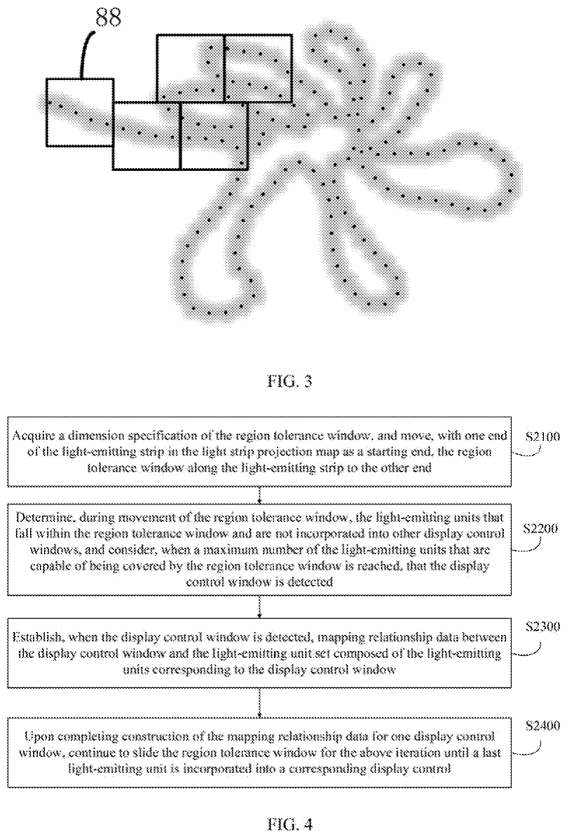

Based on any embodiment of the method of the present disclosure, referring to FIG. 4, dividing the light-emitting strip in the light strip projection map into the plurality of light-emitting unit sets by using the region tolerance window to correspondingly form the plurality of display control windows, includes:

In step S2100, a dimension specification of the region tolerance window is acquired, and with one end of the light-emitting strip in the light strip projection map as a starting end, the region tolerance window is moved along the light-emitting strip to the other end.

In this embodiment, the dimension specification of the region tolerance window may be preset. The region tolerance window may be set as a rectangular window based on a preset coordinate system, and may be represented by window coordinates. The area of the region tolerance window may be set as required.

Since the sequence information corresponding to each of the light-emitting units has been marked in the pattern data of the light-emitting strip in the light strip projection map, a power access terminal therein can be determined, which is typically the end at which the first light-emitting unit arranged in the position distribution information is located, and then the power access terminal is used as the starting end to start to apply the region tolerance window and move the region tolerance window along the light-emitting strip to search for the light-emitting unit.

In step S2200, during the movement of the region tolerance window, the light-emitting units that fall within the region tolerance window and are not incorporated into other display control windows are determined, and when the maximum number of the light-emitting units that are capable of being covered by the region tolerance window is reached, it is considered that the display control window is detected.

Since the position coordinates of each of the light-emitting units have been calibrated in the light strip projection map, the connection line between every two light-emitting units adjacent in sequence can be determined based on the position coordinates. Then, during the movement of the region tolerance window, the region tolerance window is advanced to the light-emitting unit that comes into contact first in sequence, so that the light-emitting unit enters the region tolerance window to realize preliminary positioning, and then whether the position coordinates of other subsequent light-emitting units in the direction of the connection line enter the coverage range of the region tolerance window is sequentially determined. If so, the corresponding light-emitting unit is considered to be incorporated into the display control window corresponding to the current position of the region tolerance window.

Since the direction of the connection line is often curved, in some embodiments, it is also possible to move the region tolerance window in a direction perpendicular to the advancing direction of the connection line on the basis of preliminary positioning, so as to continuously search for the light-emitting units covered by the region tolerance window. The position with the maximum number of light-emitting units found is fixed as the position where the display control window is located, and the range covered by the region tolerance window at this time is used as the range corresponding to the display control window.

It can be seen that by using the region tolerance window to search for light-emitting units in the direction of the connecting line in the light strip projection map, as many light-emitting units as possible within a fixed area range can be obtained, the position where the region tolerance window is located when the most light-emitting units are obtained is used as the position where the display control window is located, and the area of the region tolerance window is used as the area of the display control window. Therefore, the display control window and all the light-emitting units incorporated therein are determined.

In step S2300, when the display control window is detected, mapping relationship data between the display control window and the light-emitting unit set composed of the light-emitting units corresponding to the display control window is established.

In the previous step, the window position of the display control window in the preset coordinate system is determined, and meanwhile, the corresponding light-emitting unit set thereof is determined. Accordingly, the corresponding relationship between the display control window and each of the light-emitting units in the light-emitting unit set thereof can be constructed as the mapping relationship data. The mapping relationship data can be embodied by marking each of the light-emitting units in the pattern data in the light strip projection map, or by separately constructing corresponding memory data in the memory, and then calling the memory data correspondingly.

In step S2400, upon completing the construction of the mapping relationship data for one display control window, the region tolerance window is continued to be slid for the above iteration until the last light-emitting unit is incorporated into a corresponding display control window.

In the process of using the region tolerance window for moving detection, after one display control window is determined, the light-emitting units incorporated in the display control window no longer participate in subsequent detection. Accordingly, the light-emitting unit entering the outside of the display control window can be directly positioned to continue the detection of the next display control window, and then the above process is repeated. Specifically, the loop iteration is continued from step S2200, so that a new display control window is continuously determined until the last light-emitting unit in the light-emitting strip is incorporated in the corresponding display control window, that is, the detection of all display control windows of the light-emitting strip is completed.

Based on the above embodiments, it can be seen that this embodiment can fully adapt to the characteristics that the light-emitting strip is bent and folded after shaping, and reconstruct the control granularity of the light-emitting units in the light-emitting strip to obtain a plurality of display control windows, so that each display control window is substantially consistent on the projection plane, while a different number of light-emitting units may be accommodated. Therefore, when the display control window is used as a batch control unit for the generation of light-emitting control data and the control of lighting effect playback, the control granularity presented on the projection plane of the light-emitting strip is relatively uniform, and the area difference on the plane caused by the bending and folding of the light-emitting strip is approximately balanced, so that the playback of the lighting effects can be more in line with expectations, and the display effect of the lighting effects is ensured.

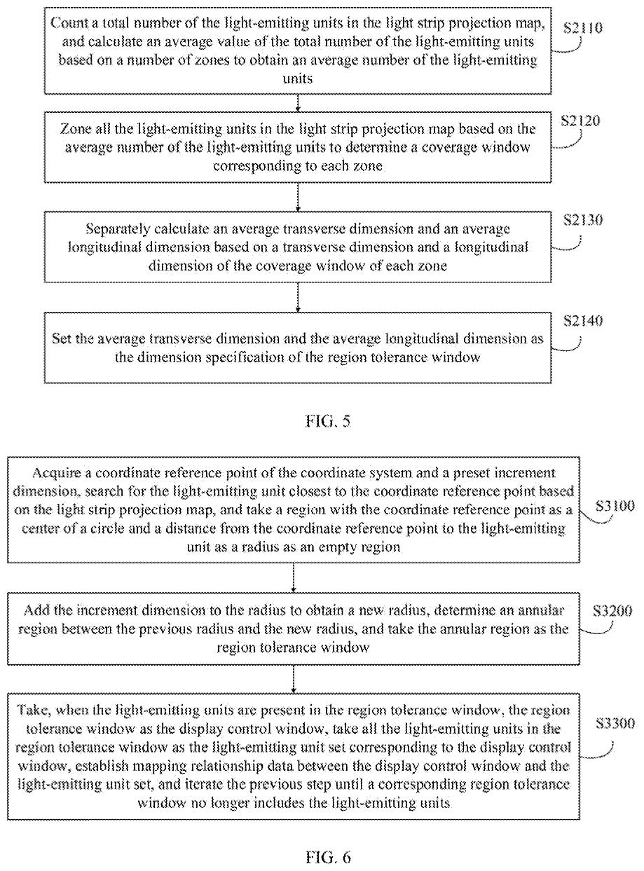

Based on any embodiment of the method of the present disclosure, referring to FIG. 5, acquiring the dimension specification of the region tolerance window, includes:

In step S2110, the total number of the light-emitting units in the light strip projection map is counted, and the average value of the total number of the light-emitting units is calculated based on the number of zones to obtain the average number of the light-emitting units.

In this embodiment, the number of the light-emitting units in the light strip projection map can be counted first to obtain the total number of the light-emitting units. In addition, a number of zones may be preset to indicate the number of display control windows divided for the light-emitting strip, so as to regulate the control granularity during the playback of lighting effects based on the number of zones. The number of zones may be made configurable by the controller via a graphical user interface, allowing a user to set it according to actual needs. On this basis, the total number of the light-emitting units is divided by the number of zones to obtain the average number of light-emitting units, that is, the average number of light-emitting units that can be allocated to each display control window. It should be noted that the number of zones here is not the total number of display control windows finally obtained, because after the light-emitting strip is bent and folded, the number of light-emitting units included in the same display control window may be greater than or less than the average number of light-emitting units. Therefore, the total number of display control windows finally obtained may not be equal to the preset number of zones.

In step S2120, all the light-emitting units in the light strip projection map are zoned based on the average number of the light-emitting units to determine a coverage window corresponding to each zone.

After the average light-emitting unit data is determined, all the light-emitting units in the light-emitting strip are zoned based on the position coordinates and sequence information of each of the light-emitting units defined in the pattern data of the light strip projection map to obtain a plurality of zones. Each zone preferentially includes a plurality of light-emitting units consistent with the average number of light-emitting units, where if there are redundant light-emitting units insufficient for the average number of light-emitting units, all of the finally redundant light-emitting units may be defined as the same single zone. After each zone is determined, the connection between the position coordinates of the light-emitting units at the head and tail ends in each zone is used as a diagonal line to determine the window coordinates of the corresponding zone. The definition of each zone is completed, and the coverage window corresponding to each zone is determined.

In step S2130, an average transverse dimension and an average longitudinal dimension are separately calculated based on the transverse dimension and the longitudinal dimension of the coverage window of each zone.

It is not difficult to understand that based on the window coordinates of each zone, which are typically the position coordinates of two light-emitting units, at the head and tail ends, covered by the zone, the transverse dimension and the longitudinal dimension of the corresponding zone can be determined, and the transverse dimension and the longitudinal dimension of each zone can be obtained.

Further, the average value of the transverse dimensions of all zones is calculated to obtain the average transverse dimension, and the average value of the longitudinal dimensions of all zones is calculated to obtain the average longitudinal dimension.

In step S2140, the average transverse dimension and the average longitudinal dimension are set as the dimension specification of the region tolerance window.

After the average transverse dimension and the average longitudinal dimension are determined, the two may be defined as the dimension specification corresponding to the region tolerance window. In some embodiments, according to actual needs, a preset tolerance dimension may also be added to the average transverse dimension and the average longitudinal dimension to appropriately expand the area of the region tolerance window.

It can be known from the above embodiments that the present disclosure further provides means for adjusting the control granularity to the user of the ambient light device. The user can scale the size of the display control window by presetting the number of zones, so as to adjust the control granularity for the display of lighting effects, which can improve the convenience of control of the ambient light device and improve the product user experience. Based on the control mechanism realized, it is convenient for the user to adapt to the linear characteristic of the light-emitting strip, and to define and display the streamlined lighting effects.

Based on any embodiment of the method of the present disclosure, referring to FIG. 6, dividing the light-emitting strip in the light strip projection map into the plurality of light-emitting unit sets by using the region tolerance window to correspondingly form the plurality of display control windows, includes:

In step S3100, a coordinate reference point of the coordinate system and a preset increment dimension are acquired, the light-emitting unit closest to the coordinate reference point is searched for based on the light strip projection map, and a region with the coordinate reference point as the center of a circle and a distance from the coordinate reference point to the light-emitting unit as a radius is taken as an empty region.

As disclosed above, a coordinate system corresponding to the light strip projection map is preset in the controller according to the present disclosure, and a coordinate reference point of the coordinate system can be determined accordingly. In addition, in order to facilitate the implementation of the control with the circular ring as the control granularity in this embodiment, the controller can also acquire an increment dimension, and the increment dimension can be set in advance; similarly, the increment dimension can be set by the user via a graphical user interface provided by the controller. The coordinate reference point may be a coordinate origin by default, or may be set by the user in the coordinate system in advance.

The distance from each light-emitting unit in the light strip projection map to the coordinate reference point can be calculated based on its position coordinates, so that the distance from each light-emitting unit to the coordinate reference point can be compared. The minimum distance among the distances can be determined as the radius of the empty region; the region obtained by drawing a circle with the coordinate reference point as the center of a circle and the minimum distance as the radius is the empty region. The empty region is understood as a region without any light-emitting units, and even the light-emitting unit corresponding to the minimum distance is subsequently incorporated in the corresponding region tolerance window.

In step S3200, the increment dimension is added to the radius to obtain a new radius, an annular region between the previous radius and the new radius is determined, and the annular region is taken as the region tolerance window.

After the radius corresponding to the previous circle is obtained, the radius is used as an old radius, and a preset increment dimension is added to obtain a new radius. Then, a circle is drawn still with the coordinate reference point as the center of the circle and with the new radius, and the new circle is subtracted from the previous circle to obtain an annular region; the annular region is the region tolerance window.

In step S3300, when the light-emitting units are present in the region tolerance window, the region tolerance window is taken as the display control window, all the light-emitting units in the region tolerance window are taken as the light-emitting unit set corresponding to the display control window, mapping relationship data between the display control window and the light-emitting unit set is established, and the previous step is iterated until the corresponding region tolerance window no longer includes the light-emitting units.

When the region tolerance window is covered with the light-emitting units, that is, the number of the light-emitting units is not 0, the region tolerance window may constitute a display control window. Correspondingly, each light-emitting unit entering the display control window also constitutes a light-emitting unit set corresponding to the display control window. In this way, as disclosed above, the mapping relationship data between the display control window and the light-emitting unit set thereof can be established for subsequent calling.

After the construction of the mapping relationship data for one display control window is completed, the current corresponding radius may be taken as the old radius, and the process can return to step S3200 to continue the iteration, thereby repeating the iteration continuously until the number of light-emitting units included in the corresponding region tolerance window is 0.

It can be learned from the above embodiments that in the present disclosure, the definition form of the control granularity may be changed, determines the display control window in the form of an annular region, and allows the user to adjust the dimensions of the annular region. In this way, it is convenient for the user to define radial lighting effects based on the light-emitting strip, realizing effective display of lighting effects.

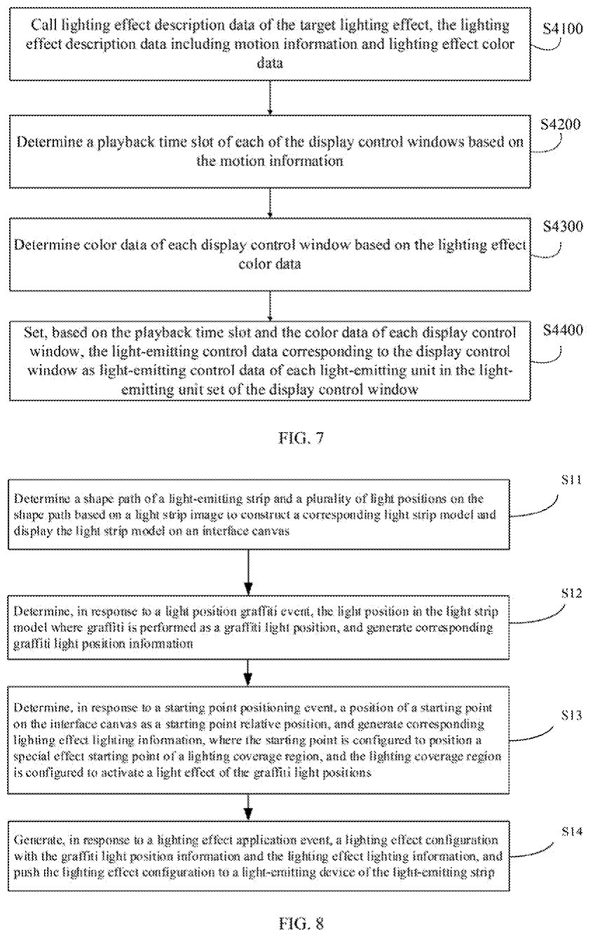

Based on any embodiment of the method of the present disclosure, referring to FIG. 7, generating, with each display control window as the batch control unit, the light-emitting control data corresponding to the target lighting effect for the light-emitting unit set of each display control window, includes:

In step S4100, the lighting effect description data of the target lighting effect is called, the lighting effect description data including motion information and lighting effect color data.

As disclosed above, the target lighting effect to be played is represented in the form of lighting effect description data, and accordingly, the lighting effect description data of the target lighting effect can be called and parsed to obtain the motion information and lighting effect color data therein. For example, the motion information in the lighting effect description data can define a streamlined motion mode, indicating that lighting effects in each display control window are displayed in a flowing manner in the direction of the light-emitting strip. The lighting effect color data in the lighting effect description data is similarly used to define the colors to be displayed by each display control window, for example, defined as random colors.

In step S4200, a playback time slot of each of the display control windows is determined based on the motion information.

For example, the motion information is defined as a streamlined motion mode. The motion information may include the entire duration for completing the display of the target lighting effect, e.g., 2 seconds, and the number of display control windows in the light-emitting strip is determined. Therefore, the playback duration corresponding to each display control window can be obtained by dividing the entire duration by the number of the display control windows, and the playback time slot corresponding to each display control window can be determined accordingly.

In step S4300, the color data of each display control window is determined based on the lighting effect color data.

Based on the lighting effect color data, taking the color value of each display control window defined in the lighting effect description data as a random color as an example, for each display control window, a color value can be randomly generated as its corresponding color data.

In step S4400, based on the playback time slot and the color data of each display control window, the light-emitting control data corresponding to the display control window is set as the light-emitting control data of each light-emitting unit in the light-emitting unit set of the display control window.

After the playback time slot and the color data corresponding to each display control window are determined, the controller can adapt to the protocol between the controller and the control chip of the light-emitting unit, and encapsulate the light-emitting control data corresponding to each display control window, so that the light-emitting control data includes the corresponding color data and is associated with the corresponding playback time slot. It should be noted that since the light-emitting control data corresponding to the display control window is also the light-emitting control data corresponding to each light-emitting unit in the display control window, the light-emitting control data of each light-emitting unit corresponding to the display control window can be directly assigned values based on the light-emitting control data of the display control window.

According to the above embodiments, it can be seen that since all the light-emitting units in the display control window adopt the same light-emitting control data, it is not necessary to construct the light-emitting control data individually, which can effectively reduce the calculation amount corresponding to the generation of light-emitting control data by the controller, reduce the system overhead of the controller, and improve the robustness of the controller during operation.

Based on any embodiment of the method of the present disclosure, controlling the light-emitting strip to play the target lighting effect based on the light-emitting control data, includes:

In step S5100, in the playback time slot corresponding to each display control window, the light-emitting control data corresponding to the display control window is transmitted to the light-emitting strip as the light-emitting control data of each of the light-emitting units corresponding to the display control window.

As disclosed above, the light-emitting control data of each display control window includes the corresponding color data and is associated with the corresponding playback time slot. Accordingly, in the playback time slot corresponding to each display control window, the light-emitting control data corresponding to the display control window can be assigned to the light-emitting control data of each light-emitting unit corresponding to the display control window, and these light-emitting control data can be encapsulated into a data packet according to a predetermined protocol format and sent to the light-emitting strip.

In step S5200, corresponding lighting effects are played by each of the light-emitting units in the light-emitting strip corresponding to the display control window based on the light-emitting control data.

After receiving the data packet, each light-emitting unit in the light-emitting strip extracts the light-emitting control data corresponding to itself according to a preset protocol, and then controls its own light-emitting element to emit light of a corresponding color based on the color data in the light-emitting control data. Since the same display control window adopts the same light-emitting control data, all the light-emitting units in the entire display control window emit lighting effects of the same color.

It is not difficult to understand that when each display control window is successively controlled to emit corresponding light, the entire target lighting effect can be played and displayed.

It can be known from the above embodiments that taking the display control window as a batch control unit to uniformly control all the light-emitting units in the display control window actually redefines the control granularity of the light-emitting strip. Since the display control windows are substantially similar in area, the effect obtained by performing light emission control on the projection plane of the light-emitting strip of the ambient light device is necessarily relatively uniform and harmonious, and the displayed lighting effects can better create the desired sense of immersion.

The controller 1 in the light-emitting device may receive a lighting effect configuration from an external terminal device. The controller 1 in the light-emitting device acquires, based on graffiti light position information and lighting effect lighting information in the lighting effect configuration, one or a plurality of graffiti light positions and a graffiti light color in the graffiti light position information, so as to determine a target light bead corresponding to each graffiti light position in the light-emitting strip 21, and generates a lighting effect light color corresponding to each target light bead 2 based on the graffiti light color. The controller acquires a starting point relative position, a lighting coverage region, and a rotation speed in the lighting effect lighting information, determines a special effect starting point relative to the light-emitting strip 21 based on the starting point relative position, and controls the lighting coverage region to rotate around the special effect starting point at the rotation speed. The controller monitors the rotation process of the lighting coverage region, and determines target light beads in the light-emitting strip 21 over which the lighting coverage region currently rotates, so as to control the target light beads to emit corresponding lighting effect light colors.

According to the product architecture and working principle of the light-emitting device described above, the method for editing a lighting effect light-emitting region of a light-emitting device according to the present disclosure can be implemented as a computer program product running in a user terminal connected to the light-emitting device. Accordingly, referring to FIG. 8, in some embodiments, the method for editing a lighting effect light-emitting region according to the present disclosure includes:

In step S11, a shape path of a light-emitting strip and a plurality of light positions on the shape path are determined based on a light strip image to construct a corresponding light strip model and display the light strip model on an interface canvas.

According to the present disclosure, the shape path formed after a user shapes the light-emitting strip may be determined based on image analysis performed on the light strip image obtained by photographing the light-emitting strip adopted in a light strip body in the light-emitting device. Meanwhile, the light positions distributed on the shape path may also be determined during the image analysis. The light position referred to herein is a light-emitting unit used for indicating the shape path obtained based on the image analysis of the light strip image. The light-emitting unit may be set corresponding to a light-emitting unit in the light-emitting strip, or may be set corresponding to a plurality of light-emitting units of a standard quantity or within a standard length range in the light-emitting strip. Therefore, at a computer program level, the light position may be represented as a section in the shape path, where each section may correspond to and indicate coverage of one or several light-emitting units; or the light position may be represented as a node in the shape path, where each node represents only one light-emitting unit in the shape path. During actual implementation, a selection may be made based on requirements, so as to make zone management of the light-emitting strip more flexible. For ease of understanding, each light position mentioned in the following embodiments of the present disclosure may be regarded as one light-emitting unit in the corresponding light-emitting strip, and each light-emitting unit is equivalent to each light bead in the light-emitting strip.

The user terminal can acquire the light strip image by photographing the light-emitting strip by means of a photographing unit thereof, such as a camera of the user terminal, so as to generate an image having the light-emitting strip as the light strip image; or the photographing unit is a camera device connected to the light-emitting device to photograph the light-emitting strip, so as to generate a corresponding light strip image, and push the light strip image to the user terminal connected to the light-emitting device, so that the user terminal acquires the light strip image to construct a corresponding light strip model.

There are various modes to determine the shape path of the light-emitting strip based on the light strip image, and any of the following modes may be selected for implementation.

In one embodiment, the user terminal can perform image segmentation based on the light strip image to obtain an image mask corresponding to the light-emitting strip in the light strip image. The image mask actually describes a region where the shape of the light-emitting strip in the light strip image is located, that is, a shape region. Since the shape region of the light-emitting strip is necessarily linear, the shape path of the light-emitting strip is also defined by the shape region. In this embodiment, the light strip image may be an image before the light-emitting strip lights up or after the light-emitting strip lights up. Determining the shape path in an end-to-end manner according to this mode is more precise.

In another embodiment, binarization conversion may be performed on the light strip image, and edge detection may be performed by means of various known edge detection algorithms on the basis of a converted binarized image, thereby obtaining the shape region to define the shape path of the light-emitting strip. Similarly, in this embodiment, the light strip image may be an image before the light-emitting strip lights up or after the light-emitting strip lights up. Determining the shape path according to this mode features a low computational load, rapid identification, and low implementation cost, which is more economical.

In the above two embodiments for determining the shape path of the light-emitting strip, in order to improve the accuracy of shape path detection, prior to acquiring the single light strip image, a lighting instruction may be first sent to the light-emitting device via the terminal device to cause the light-emitting device to first control the light-emitting strip to light up, and then the camera unit is started to obtain the light strip image. Since the light-emitting strip is in a lit state in this case, the light-emitting strip in the obtained light strip image is brighter. Whether performing image segmentation or performing edge detection, the shape region of the light-emitting strip in the light strip image can be determined more accurately with the aid of the bright feature.

In yet another embodiment for determining the shape path of the light-emitting strip based on the light strip image, after enabling the camera unit of the terminal device to perform camera preview, two frames of light strip images, before and after the light-emitting strip lights up, may be acquired, and frame difference information is solved after aligning the two light strip images. In the frame difference information, pixels corresponding to a position where the light-emitting strip is located obtain significant numerical values, and a set of pixels having the significant numerical values constitutes the shape region of the light-emitting strip, thereby defining the corresponding shape path. This mode similarly has the advantages of a low computational load, fast speed, and high efficiency.

After the shape path of the light-emitting strip is determined, the light positions distributed on the shape path can be further detected. There are also multiple modes to determine the light positions on the shape path, and any of the following modes may be selected for implementation.

In one embodiment, the user terminal calculates the actual dimension corresponding to the light strip image in a physical space based on an imaging focal length of the light strip image; then, calculates the length of the shape path based on a shape region in the light strip image as the actual dimension of the light-emitting strip; and finally, segments the shape path based on a preset zone occupancy parameter, where each segment constructs one corresponding light position. The zone occupancy parameter may be a spacing between two adjacent light beads in the light-emitting strip, or may be the total number of light beads of the light-emitting strip. By evenly dividing the actual dimension based on the spacing or the total number, each section can be determined, thereby determining each of the light positions. The zone occupancy parameter may further be used to indicate a standard number of light beads constituting one light position, and the division setting can be performed by treating one group of light beads of the standard number as one light position. According to this embodiment, in the case where the zone occupancy parameter is preset, each of the light positions in the light strip image can be automatically determined without relying on whether the light-emitting strip is lit. An algorithm for determining the light positions is determined in association with a physical focal length of imaging, which is relatively accurate, requires no manual intervention, and is more efficient. The zone occupancy parameter may be preset by a user or utilize a factory default setting provided by an application.

In another embodiment, the light-emitting device is driven first to control each of the light beads of the light-emitting strip to operate at high brightness with a specific color distribution, causing two adjacent light beads to display different colors; in the light strip image, along the shape path of the light-emitting strip, the shape path is divided into a plurality of sections based on different characteristics of the light radiated by adjacent light beads, where each section constitutes one corresponding light position. Determining the light positions according to this method does not need to rely on the zone occupancy parameter and thus possesses more flexible applicability; that is, determining the light positions is not constrained by factors such as the length of the light-emitting strip and the spacing between the light beads. Regardless of how long the length of the light-emitting strip is, or how much the spacing between the light beads is, each of the light positions therein can be effectively identified. The specific lighting instruction used herein may further be used in combination with the embodiment described above regarding the determination of the shape path using an image of the light-emitting strip after lighting up. That is, controlling the light-emitting strip to light up via the specific lighting instruction at a first time to obtain the light strip image after lighting up can be used for both determining the shape path and determining the light positions in this embodiment. It can be seen that this embodiment can possess an efficiency advantage of organic combination with the embodiment described above regarding the determination of the shape path using the image after lighting up.

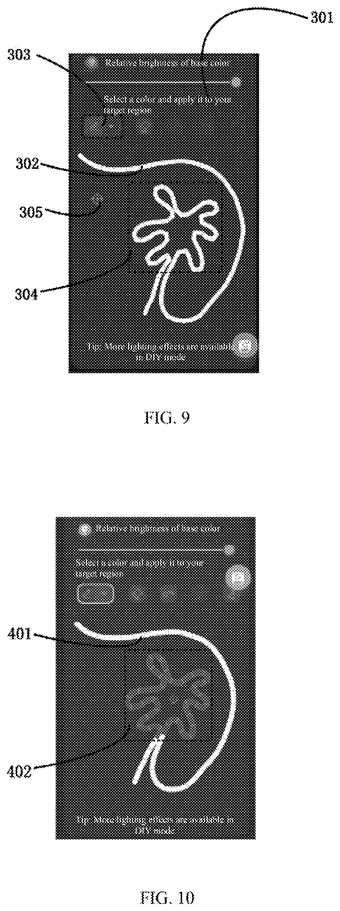

Referring to FIGS. 1 and 10, after the shape path and each of the light positions of the light-emitting strip in the light strip image are determined, an interface canvas is set in the graphical user interface of the user terminal, and thus a reference coordinate system is defined. Then, the shape path is constructed as a light strip model and is positioned and displayed on the interface canvas, being displayed centered relative to the overall layout to obtain a better visual effect. Meanwhile, when the light strip model is constructed, the light positions distributed along the shape path are also marked at corresponding positions; that is, a visual identifier is displayed for each of the light positions on the shape path represented by the light strip model. Therefore, the user at the user terminal can use the interface canvas to perform graffiti on graffiti light positions among the light positions of the light strip model on the interface canvas, and drag a starting point on the interface canvas to custom-edit a special effect starting point of a lighting coverage region, where the lighting coverage region is configured for controlling a lighting effect lighting sequence of different graffiti light positions. For details, reference is made to the following related embodiments. As shown in the graphical user interface in FIG. 9, a light strip model 302 corresponding to a light-emitting strip is displayed on the interface canvas 301 shown in the graphical user interface. It can be seen that the light strip model 302 displays the shape path and each of light positions of the light-emitting strip 21 shown in FIG. 1. The user may perform a graffiti operation at the graffiti light position on the shown interface canvas 301 to perform graffiti at the graffiti light position of the shown light strip model 302; the graffiti light position corresponds to a light bead in the shown light-emitting strip 21. The user performs a drag operation at a starting point of the shown interface canvas 301 to custom-edit a special effect starting point of a lighting coverage region, which acts on a lighting effect lighting sequence of light beads corresponding to graffiti light positions in the shown light-emitting strip 21.

In step S12, in response to a light position graffiti event, the light positions in the light strip model where graffiti is performed are determined as graffiti light positions, and corresponding graffiti light position information is generated.

After the light strip model corresponding to the light-emitting strip is output to the interface canvas for display, the user may perform a graffiti operation at the graffiti light position on the interface canvas, so as to trigger the user terminal to respond to a light position graffiti event, and determine the light positions in the light strip model on the interface canvas where graffiti is performed as graffiti light positions.

When the user performs the graffiti operation at the graffiti light position on the interface canvas, a corresponding graffiti light color is selected, and a graffiti brush of the selected graffiti light color is used to perform graffiti on the interface canvas, so as to perform the graffiti operation on the light strip model on the interface canvas. The user may perform graffiti by tapping and touching the touch interface canvas, and by means of the graffiti, the light positions in the light strip model are painted with the graffiti light color. The light position where the graffiti is performed is used as the graffiti light position for emitting a chasing light effect, and a light color emitted by the graffiti light position corresponds to the graffiti light color corresponding to the graffiti brush.

Referring to FIGS. 9 and 10, the graffiti light color selection control 303 shown in FIG. 9 is configured to select a graffiti light color. If the graffiti light color selected by the shown graffiti light color selection control 303 is red, the graffiti brush used by the user to perform the graffiti operation on the shown interface canvas 301 will be a red graffiti brush. After the user uses the red graffiti brush to perform graffiti on a light strip region 304 in the shown light strip model 302, the light strip model 302 shown in FIG. 9 will change to the light strip model 401 shown in FIG. 10. The light strip region 402 of the shown light strip model 401 corresponds to the shown light strip region 304 of the shown light strip model 302, the color of each light position in the shown light strip region 402 is painted red by the red graffiti brush, and the light positions will be used as the graffiti light positions. In the light-emitting strip corresponding to the shown light strip model 401, the light beads corresponding to the light positions will emit light effects of the red light color.

Referring to FIG. 11, certainly, the user may use a graffiti brush with different graffiti light colors to perform the graffiti operation. After completing the graffiti operation by using the graffiti brush with one graffiti light color, the user may select another graffiti light color to perform the graffiti operation by using the graffiti brush with another graffiti light color, so as to graffiti the light positions in the light strip model on the interface canvas into graffiti light positions with different graffiti light colors, so that the user may design light effects with different lighting effect light colors to meet personalized requirements of the user. On the interface canvas shown in FIG. 11, the light strip model has the graffiti light positions with three graffiti light colors of red, blue, and green.

Regarding how the user terminal determines the graffiti light position in the light strip model where graffiti is performed, specifically, after the user terminal generates a corresponding graffiti brush based on the graffiti light color selected by the user for the user to perform the graffiti operation, the user terminal detects a graffiti path of the graffiti brush on the interface canvas. That is, when the user taps and touches the interface canvas to draw the graffiti with the graffiti brush, the tapped and touched position on the interface canvas is detected as the graffiti path. When the graffiti path passes through the light strip model on the interface canvas, the light position in the light strip model through which the graffiti path passes is determined as the graffiti light position, and the color of the graffiti light position is modified to the graffiti light color. It can be understood that the user may use the graffiti brush to randomly perform graffiti on the interface canvas, but not all of the graffiti paths of the graffiti brush are displayed on the interface canvas, only the graffiti paths passing through the light strip model are displayed, and the displayed graffiti path is displayed by modifying the light position in the light strip model through which the graffiti path passes into the graffiti light position of the graffiti light color, so that the user is aware of the graffiti path of the graffiti brush; in addition, the graffiti path of the graffiti brush is not completely displayed on the interface canvas, which can prevent the graffiti path that does not pass through the light strip model from interfering with the user's observation of the light strip model, and ensure the user's graffiti operation experience.

After the user terminal detects the graffiti light position in the light strip model and modifies the light position color, the corresponding graffiti light position information is also generated to record the graffiti light position in the light strip model and the graffiti light color thereof, so that when the graffiti light position information is subsequently pushed to the light-emitting device, the light-emitting device can determine the light beads corresponding to the graffiti light positions in the light-emitting strip based on the graffiti light position information, and the light colors used when the light beads emit chasing light effects.

In step S13, in response to a starting point positioning event, the position of a starting point on the interface canvas is determined as a starting point relative position, and corresponding lighting effect lighting information is generated, where the starting point is configured to position a special effect starting point of a lighting coverage region, and the lighting coverage region is configured to activate a light effect of the graffiti light positions.

In addition to performing the graffiti operation to custom-graffiti the graffiti light positions in the light strip model that need to emit light effects, the user can also customize the position of the special effect starting point of the lighting coverage region, which controls the lighting effect lighting sequence of the graffiti light positions.

The lighting effects of the present disclosure are formed by moving the lighting coverage region based on the special effect starting point to control the lighting sequence of the light beads in the light-emitting strip that emit light effects, for example, a rotating chasing light effect formed by a lighting coverage region that rotates based on the special effect starting point, a diffusion lighting light effect formed by a lighting coverage region that diffuses the lighting of light beads based on the special effect starting point, a contraction lighting light effect formed by a lighting coverage region that contracts the lighting of light beads based on the special effect starting point, and a translational lighting light effect formed by a lighting coverage region that lights the light beads in a translational manner based on the special effect starting point. Certainly, those skilled in the art can also flexibly design other light effects formed by the lighting coverage region moving based on the special effect starting point, and details are not described herein again.

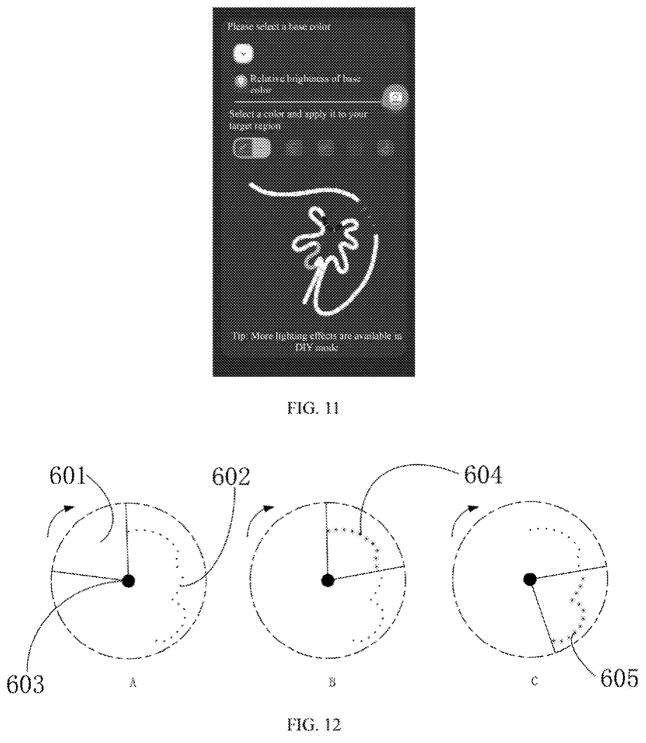

Taking the rotating chasing light effect as an example, referring to FIG. 12, the lighting coverage region is configured to trigger the light beads corresponding to the graffiti light positions in the light-emitting strip to emit light effects, that is, the light beads corresponding to the graffiti light positions within the lighting coverage region in the light-emitting strip will emit light effects, and the lighting coverage region will rotate around the special effect starting point. By rotating the lighting coverage region, the lighting effect lighting sequence of the light beads corresponding to different graffiti light positions in the light-emitting strip can be controlled. In the schematic diagram shown in FIG. 12, the region 601 shown in A in FIG. 12 is the lighting coverage region, the center 603 shown is the special effect starting point, and all light beads in the shown light-emitting strip 602 are light beads corresponding to graffiti light positions where graffiti is performed by the user. As can be seen from A, B, and C in FIG. 12, the lighting coverage region rotates around the special effect starting point, and the light beads within the lighting coverage region in the shown light-emitting strip 602 will emit light effects. As shown in B in FIG. 12, the light beads within the shown lighting coverage region 604 in the light-emitting strip all emit light effects. After that, the shown lighting coverage region 604 continues to rotate around the special effect starting point. As shown in C in FIG. 12, the light beads within the shown lighting coverage region 605 emit light effects, while the light beads outside the shown lighting coverage region 605 stop emitting light effects. It can be seen that for the light beads corresponding to the graffiti light positions in the light-emitting strip, only the light beads within the lighting coverage region emit light effects, while the light beads outside the lighting coverage region do not emit chasing light effects. Then, as the lighting coverage region rotates around the center, the light effects of the light beads corresponding to the graffiti light positions in the light-emitting strip are continuously activated and deactivated, thereby forming the rotating chasing light effect of the light-emitting strip.

Taking the rotating chasing light effect as an example, referring to FIG. 9, as described above, the rotational motion of the lighting coverage region is performed around the special effect starting point. The user can drag or touch and tap a starting point corresponding to the special effect starting point on the interface canvas to modify the position of the starting point on the interface canvas, and the position of the starting point on the interface canvas is determined as the starting point relative position. The starting point relative position refers to the position of the special effect starting point relative to the light-emitting strip. The user can modify the position of the starting point on the interface canvas to modify the position of the special effect starting point relative to the light-emitting strip, around which the lighting coverage region rotates. The position of the starting point on the interface canvas is shown in FIG. 9. The starting point 305 shown on the interface canvas shown in FIG. 9 can be randomly dragged by the user to modify the position of the starting point 305 on the interface canvas, and then the position of the special effect starting point corresponding to the shown starting point 305 relative to the light-emitting strip is modified.

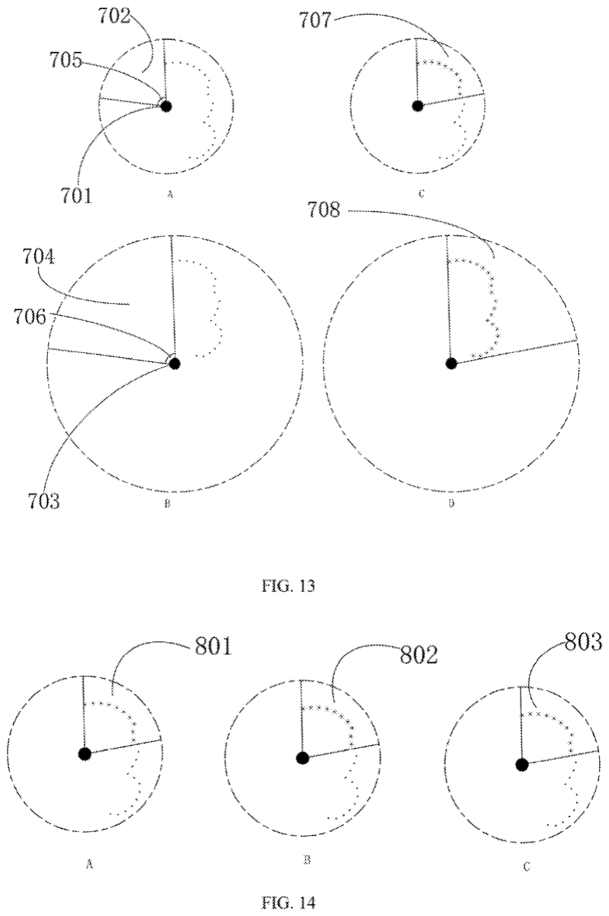

Taking the rotating chasing light effect as an example, referring to FIGS. 12 and 13, it can be seen from the lighting coverage region 601 shown in A in FIG. 12 that the lighting coverage region is typically a sector-shaped region. In the case that the included angle of the sector-shaped region remains unchanged, changing the position of the special effect starting point results in a change in the number of light beads that can be lit simultaneously within the lighting coverage region. The closer the special effect starting point is to the light-emitting strip, the fewer light beads can be lit simultaneously within the lighting coverage region; conversely, the farther the special effect starting point is from the light-emitting strip, the more light beads can be lit simultaneously within the lighting coverage region. As shown in FIG. 13, for the respective lighting coverage regions 702 and 704 shown in A and B in FIG. 13, the respective angles of the region included angle 705 and the region included angle 706 of the two shown lighting coverage regions are the same. For the shown special effect starting point 701 around which the shown lighting coverage region 702 rotates, compared with the shown special effect starting point 703 around which the shown lighting coverage region 704 rotates, the shown special effect starting point 701 is closer to the light-emitting strip, that is, the starting point relative position of the shown special effect starting point 701 is closer to the light-emitting strip compared with the shown special effect starting point 703. Moreover, by comparing the shown lighting coverage region 702 with the shown lighting coverage region 704, it can be seen that the region of the shown lighting coverage region 702 is smaller than that of the shown lighting coverage region 704. In addition, it can be seen from C and D in FIG. 13 that the lighting coverage region 707 shown in C in FIG. 13 corresponds to the shown lighting coverage region 702, and the lighting coverage region 708 shown in D in FIG. 13 corresponds to the shown lighting coverage region 704. Compared with the shown lighting coverage region 708, the shown lighting coverage region 707 has fewer light beads that can be lit simultaneously to emit light effects. Therefore, the user drags and modifies the position of the starting point on the interface canvas to modify the relative position of the special effect starting point, so that the number of light beads that can be lit to emit light effects within the lighting coverage region can be modified to meet the personalized design requirements of the user for chasing lighting effects.

The starting point for the user to touch or drag on the interface canvas can be used to control the special effect starting point of light effects such as the diffusion lighting light effect, the contraction lighting light effect, and the translational lighting light effect in addition to controlling the special effect starting point of the rotating chasing light effect. In summary, the starting point on the interface canvas can control the starting point of the lighting coverage region during movement, that is, the special effect starting point when the light effect is executed within the lighting coverage region, that is, the starting point on the interface canvas that can be custom-positioned by the user, i.e., a special effect starting point that controls where the lighting coverage region starts moving when executing a light effect.

In addition to modifying the relative position of the special effect starting point around which the lighting coverage region rotates, the user can also custom-edit other information of the lighting coverage region. Taking the rotating chasing light effect as an example, the region included angle, the rotation speed of the lighting coverage region during rotation, and the direction of the lighting coverage region during rotation are custom-edited to further meet the personalized design requirements of the user. In addition, the personalized design requirements of the light effects, such as the diffusion lighting light effect, the contraction lighting light effect, and the translational lighting light effect, can be custom-edited. Certainly, those skilled in the art can design flexibly, and details are not described herein again.

The lighting effect lighting information records the starting point relative position determined by the user by dragging the starting point, and records other information of the lighting coverage region custom-edited by the user. Taking the rotating chasing light effect as an example, the user custom-edits and adjusts the region included angle of the lighting coverage region, as well as the rotation speed of the lighting coverage region during rotation, so that the lighting effect lighting information is subsequently pushed to the light-emitting device, and the light-emitting device is driven to determine the position of the special effect starting point relative to the light-emitting strip and the region included angle of the lighting coverage region, and control the speed of the lighting coverage region when rotating around the special effect starting point based on the lighting effect lighting information.

In step S14, in response to a lighting effect application event, a lighting effect configuration with the graffiti light position information and the lighting effect lighting information is generated, and the lighting effect configuration is pushed to a light-emitting device of the light-emitting strip.

When the user completes the determination of the graffiti light position in the graffiti light strip model on the interface canvas and the relative position by dragging the starting point on the interface canvas, and applies the corresponding graffiti light position information and lighting effect lighting information to the light-emitting strip to trigger the light-emitting strip to display the corresponding chasing lighting effect, the user terminal generates a lighting effect configuration with the graffiti light position information and the lighting effect lighting information, and pushes the lighting effect configuration to a light-emitting device to which the light-emitting strip corresponding to the light strip model belongs.

After the light-emitting device receives the lighting effect configuration pushed by the user terminal, the controller of the light-emitting device controls, based on the lighting effect configuration, the lighting coverage region to move based on the special effect starting point, so as to light up the light beads corresponding to the graffiti light positions in the light-emitting strip to emit light effects, thereby forming the corresponding lighting effects. Specifically, taking the lighting effect configuration of the rotating chasing light effect as an example, the light-emitting device receives the lighting effect configuration pushed by the user terminal, the controller of the light-emitting device acquires the graffiti light position information and the lighting effect lighting information in the lighting effect configuration, and then acquires one or a plurality of graffiti light positions and a graffiti light color in the graffiti light position information, so as to determine a target light bead corresponding to each graffiti light position in the light-emitting strip; generates the lighting effect light color corresponding to each target light bead based on the graffiti light color; and acquires the starting point relative position, the region included angle, and the rotation speed in the lighting effect lighting information, and then determines the special effect starting point relative to the light-emitting strip based on the starting point relative position and controls the lighting coverage region with the region included angle to rotate around the special effect starting point at the rotation speed. After that, the controller monitors the rotation process of the lighting coverage region in real time, and determines target light beads in the light-emitting strip over which the lighting coverage region currently rotates, so as to control the target light beads to emit corresponding lighting effect light colors.

In addition, referring to FIG. 14, the user may design a plurality of lighting effect configurations corresponding to chasing lighting effects to control the light-emitting strip to generate different chasing lighting effects. Different lighting effect configurations have different lighting effect levels, and the lighting coverage region with a lighting effect configuration of a higher lighting effect level covers the lighting coverage region with a lighting effect configuration of a lower lighting effect level. As shown in FIG. 14, taking the rotating chasing light effect as an example, the lighting effect level of the lighting effect configuration to which the chasing lighting coverage region 801 shown in A in FIG. 14 belongs is higher than the lighting effect level of the lighting effect configuration to which the chasing lighting coverage region 802 shown in B in FIG. 14 belongs. Therefore, as shown in C in FIG. 14, when the chasing lighting coverage region 801 and the chasing lighting coverage region 802 are at the same position, among the light-emitting light beads, those corresponding to the graffiti light positions located in the shown chasing lighting coverage region 801 and the shown chasing lighting coverage region 702 emits the lighting effect light color of the light beads corresponding to the shown chasing lighting coverage region 801.

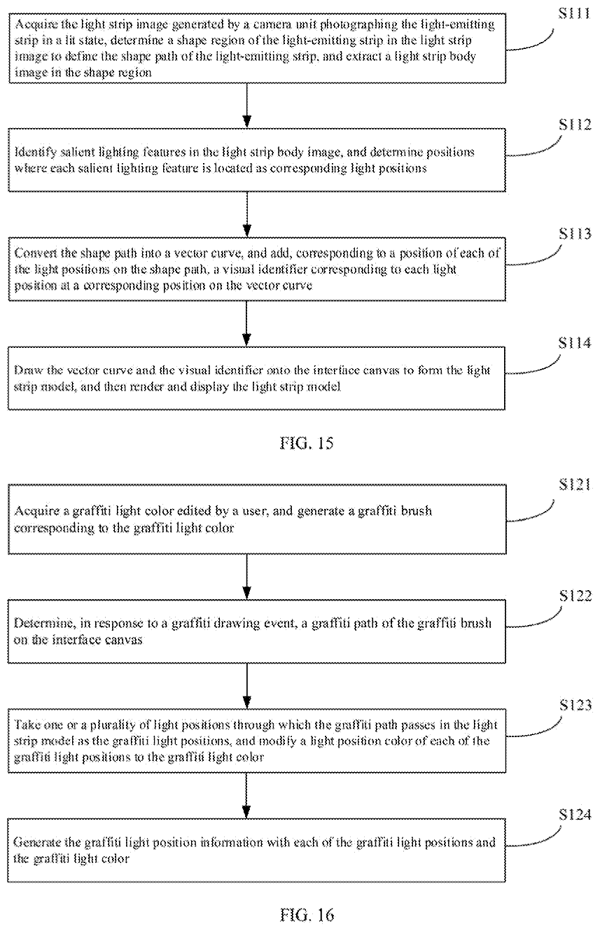

Based on any embodiment of the method of the present disclosure, referring to FIG. 15, determining the shape path of the light-emitting strip and the plurality of light positions on the shape path based on the light strip image to construct the corresponding light strip model and display the light strip model on the interface canvas, includes:

In step S111, the light strip image generated by a camera unit photographing the light-emitting strip in a lit state is acquired, a shape region of the light-emitting strip in the light strip image is determined to define the shape path of the light-emitting strip, and a light strip body image in the shape region is extracted.

When the user terminal calls the camera unit thereof to collect the light strip image, a lighting instruction is automatically sent to the light-emitting device in the background. After receiving the lighting instruction, the controller of the light-emitting device controls the light-emitting strip to light up and operate. The lighting instruction may contain light-emitting feature information indicating that adjacent light-emitting units of the light-emitting strip display different colors and the like. The controller converts the light-emitting feature information into control data for each light-emitting unit to constitute lighting effect control data, and sends the lighting effect control data to each light-emitting unit of the light-emitting strip, thereby ensuring that colored lights emitted by two adjacent light-emitting units are different, for example, causing the light-emitting strip to emit light in an order of red, green, blue, red, green, blue . . .

After the user terminal issues the lighting instruction, its own camera unit is started to collect image data, and preview images are obtained in the background. Then, target identification or instruction feature detection is performed on each preview image; when one of the preview images contains the light-emitting strip, the user can be reminded to photograph to acquire the light strip image. When performing the target identification, the target identification can be implemented by means of a target detection model; when performing the instruction feature detection, it can be detected whether a light-emitting feature corresponding to the light-emitting feature information set in the lighting instruction exists in the light strip image. When the light-emitting feature corresponding to the light-emitting feature information exists in the light strip image, the user can be reminded to photograph.

In some other embodiments, the user can independently control the light-emitting device to light up the light-emitting strip thereof, and then the user uses the terminal device to perform manual photographing to obtain the light strip image of the light-emitting strip. In some other embodiments, the terminal device can make the lighting instruction available for the user to invoke, which is triggered by the user on demand through a triggering mode such as a control key in a graphical user interface.

For the light strip image obtained in the lit state, since the light-emitting strip is in the lit state, the light-emitting strip region in the light strip image is relatively bright and easier to identify. In this case, as disclosed in the above various embodiments, edge detection or image segmentation technology can be utilized to perform detection on the light strip image, to determine an image content region of the light-emitting strip in the light strip image, that is, the corresponding shape region presenting the shape of the light-emitting strip. The shape region may be represented as an image mask. In the image mask, corresponding to the light strip image, pixels covered by the image of the light-emitting strip are represented as 1, and pixels uncovered by the image of the light-emitting strip are represented as 0. As a result, a region constituted by a set of pixels with a numerical value of 1 is the shape region. Since the light-emitting strip is linear as a whole, the shape region is inevitably linear, which actually defines the shape path of the entire light-emitting strip.

In addition, to facilitate centralized identification of the light positions, further based on the shape region, such as the image mask, all pixels within the shape region can be extracted from the light strip image to constitute the light strip body image; this is equivalent to removing, based on the light strip image, all background images outside the light-emitting strip to obtain a pure light strip body image.

In step S112, salient lighting features in the light strip body image are identified, and positions where each salient lighting feature is located are determined as corresponding light positions.

In the state where the light-emitting strip emits light, if the light of the light-emitting units thereof is not softened, in the light strip body image, positions corresponding to the light-emitting units should be the brightest parts, constituting the salient lighting features. Even if the light of the light-emitting units in the light-emitting strip is subjected to softening processing by an optical path structure in the light-emitting strip, the positions corresponding to the light-emitting units can still be determined by means of the salient lighting features represented by the light-emitting feature information set in the lighting instruction. Thus, it can be seen that as long as the salient lighting features needed to be identified are determined based on an actual situation, and each of the salient lighting features is identified in the light-emitting strip, the position of each of the salient lighting features can be set as a corresponding light-emitting unit, and each light-emitting unit is taken as a corresponding light position.

Taking the light-emitting feature of alternating red, green, and blue colors exemplified above as an example, color value differences of the three colors of red, green, and blue are distinct; therefore, standard values of the three colors of red, green, and blue are directly used as a reference to identify positions of the respective maximum values of red, green, and blue color sections on the shape path of the light-emitting strip in the light strip body image as the salient lighting features; these positions are positions where the light-emitting units are located, that is, constituting the corresponding light positions.

In other examples, even if the light-emitting strip emits monochromatic light, it is also possible to detect a bright region in each region of the shape path; because the bright region is usually the region where the light-emitting unit is located, the bright region can also be taken as the salient lighting feature and set as the corresponding light position.

In step S113, the shape path is converted into a vector curve, and corresponding to a position of each of the light positions on the shape path, a visual identifier corresponding to each light position is added at a corresponding position on the vector curve.

When the light-emitting strip needs to be represented on the interface canvas, since the shape path of the light-emitting strip has been determined in advance, and the shape path is represented by the shape region, the shape path can accordingly be converted into a vector curve based on the shape region.

Specifically, the shape region of the light-emitting strip actually defines a substantially equal-width longitudinal strip-shaped path. Accordingly, along the longitudinal direction of the shape region, intermediate pixel points between two sides in the width direction of the shape region on two sides of the path are obtained, and a line connecting these intermediate pixel points can be used to define and describe the shape path. Further, smoothing processing can be performed on the shape path to make the shape path a curve with natural transitions. To facilitate computer processing, the curve can further be converted into a vector curve, and the curve is described by an approximate curve function. Similarly, any long side in the shape region can be utilized to define the shape path to obtain a corresponding vector curve. Those skilled in the art can refer to the manner disclosed above for flexible implementation, and details are not described herein again.

The light positions, detected based on the light strip image or the light strip body image therein, are naturally distributed along the shape path. In this case, a vector curve corresponding to the shape path may also be taken as a basis, and corresponding to the position of each light position on the shape path, the detected light positions are marked at the corresponding positions on the vector curve. For ease of identification, each of the light positions may be represented in any visual form, such as a dot or a short line segment, to constitute a visual identifier, so that the visual identifier can be displayed on the interface canvas along with the vector curve.

In step S114, the vector curve and the visual identifier are drawn onto the interface canvas to form the light strip model, and then the light strip model is rendered and displayed.

After the graphical description data of the light strip model is constructed from the vector curve and the visual identifier of each of the light positions, an image rendering interface of a graphics open library of a system can be invoked. Based on the graphical description data, a GPU is utilized to perform image drawing, to draw the vector curve and the visual identifier onto the interface canvas for rendering and display.

It can be known from the above embodiments that the user terminal can generate the light strip model corresponding to the light-emitting strip on the interface canvas based on photographing the light strip image of the light-emitting strip, so that the user can intuitively perform graffiti at the graffiti light position in the light strip model and confirm the starting point relative position on the interface canvas, which provides convenient human-machine interaction for the user and improves the efficiency of the user in editing the lighting effect.

Based on any embodiment of the method of the present disclosure, referring to FIGS. 9 to 11 and 16, determining, in response to the light position graffiti event, the light positions in the light strip model where graffiti is performed as the graffiti light positions, and generating the corresponding graffiti light position information, includes:

In step S121, a graffiti light color edited by a user is acquired, and a graffiti brush corresponding to the graffiti light color is generated.

The graffiti light color is custom-edited and selected by the user via controls provided on the graphical user interface of the user terminal. As shown in the graphical user interface in FIG. 9, the user may edit and select a corresponding graffiti light color via a shown graffiti light color selection control 303. After the user selects the corresponding graffiti light color via the shown graffiti light color selection control 303, the user terminal generates a graffiti brush corresponding to the graffiti light color. As shown in FIG. 9, if the selected graffiti light color in the graffiti light color selection control 303 is red, the user terminal generates a red graffiti brush.

In step S122, in response to a graffiti drawing event, a graffiti path of the graffiti brush on the interface canvas is determined.

After the user terminal generates the graffiti brush corresponding to the graffiti light color custom-edited by the user, the user may perform the graffiti operation on the interface canvas using the graffiti brush by tapping and touching or tapping and dragging on the interface canvas. Positions at which the graffiti brush taps and touches or taps and drags on the interface canvas are used as the graffiti path of the graffiti brush on the interface canvas, and the graffiti path passing through the light strip model on the interface canvas is displayed.

In step S123, one or a plurality of light positions through which the graffiti path passes in the light strip model are taken as the graffiti light positions, and a light position color of each of the graffiti light positions is modified to the graffiti light color.

Referring to FIGS. 9 and 4, the user selects a red graffiti light color via the graffiti light color selection control 303 shown in FIG. 9, and uses a red graffiti brush to perform the graffiti operation on the interface canvas 301. After the graffiti path of the graffiti brush passes through the light strip region 304 in the light strip model 302, the light strip model 302 shown in FIG. 9 changes to the light strip model 401 shown in FIG. 4. The light strip region 402 of the shown light strip model 401 corresponds to the shown light strip region 304 of the shown light strip model 302, the color of each light position in the shown light strip region 402 is painted red by the red graffiti brush, and the light positions are used as the graffiti light positions. In the light-emitting strip corresponding to the shown light strip model 401, light beads corresponding to the light positions emit light effects of the red light color.

In step S124, the graffiti light position information with each of the graffiti light positions and the graffiti light color is generated.

After the user terminal monitors the graffiti path of the graffiti brush on the interface canvas in real time and determines one or a plurality of light positions through which the graffiti path passes in the light strip model as the graffiti light positions, corresponding graffiti light position information is generated to record the graffiti light positions and a modified graffiti light color.

It can be known from the above embodiments that the user can perform the graffiti operation on the interface canvas with the light strip model of the light-emitting strip to determine the light beads that need to emit the light effect in the light-emitting strip by means of graffiti. With the light color of the light effect emitted by the light bead, an intuitive and convenient human-machine interaction method is provided. In addition to improving the efficiency of the user in determining the light beads emitting lighting effects, graffiti can also improve the fun during editing and enhance the user's motivation for lighting effect design.

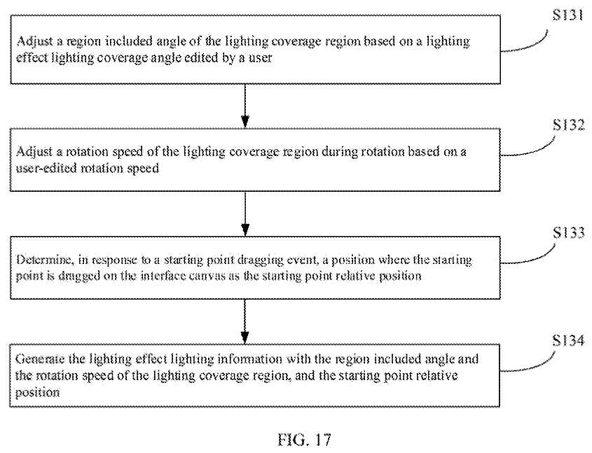

Based on any embodiment of the method of the present disclosure, referring to FIGS. 9 and 17, determining, in response to the starting point positioning event, the position of the starting point on the interface canvas as the starting point relative position, and generating the corresponding lighting effect lighting information, where the starting point is configured to position the special effect starting point of the lighting coverage region, and the lighting coverage region is configured to activate the light effect of the graffiti light positions, includes:

In step S131, a region included angle of the lighting coverage region is adjusted based on a lighting effect lighting coverage angle edited by a user.

The user may custom-edit the region angle of the lighting coverage region, thereby modifying the number of light beads that are simultaneously lit and emit the chasing light effect within the lighting coverage region. The range of the lighting effect lighting coverage angle may be typically set to 1 to 360 degrees. After the user completes the editing of the lighting effect lighting coverage angle, the user terminal may correspondingly adjust the region included angle of the lighting coverage region based on the lighting effect lighting coverage angle. For example, when the lighting effect lighting coverage angle is 45 degrees, the region included angle of the lighting coverage region is correspondingly adjusted to 45 degrees.

In step S132, the rotation speed of the lighting coverage region during rotation is adjusted based on a user-edited rotation speed.

The user may custom-edit the rotation speed of the lighting coverage region when rotating around the special effect starting point. The user adjusts the rotation speed of the lighting coverage region during rotation by editing the corresponding rotation speed, and the rotation speed may be edited in segments. For example, different rotation speeds can be set for the first 180 degrees and the latter 180 degrees of the rotation of the lighting coverage region.

In addition, the user can custom-edit the rotation direction of the lighting coverage region when rotating around the special effect starting point. The user can generally select one of the clockwise direction and the counterclockwise direction, and the selected direction is used as the rotation direction of the lighting coverage region when rotating around the special effect starting point.

In step S133, in response to a starting point dragging event, a position where the starting point is dragged on the interface canvas is determined as the starting point relative position.

Referring to FIG. 9, as shown in FIG. 9, the starting point 305 shown on the interface canvas shown in FIG. 9 can be dragged randomly by the user to modify the position where the starting point 305 is located on the interface canvas, thereby modifying the starting point relative position of the special effect starting point corresponding to the shown starting point 305 relative to the light-emitting strip.

In step S134, the lighting effect lighting information with the region included angle and the rotation speed of the lighting coverage region, and the starting point relative position is generated.

By generating the lighting effect lighting information, the region included angle, the rotation speed, and the starting point relative position that are adjusted based on the custom-editing operation of the user are recorded, so that the lighting effect lighting information is subsequently pushed to the light-emitting device, and the light-emitting device is driven to determine the position of the special effect starting point relative to the light-emitting strip and the region included angle of the lighting coverage region, and control the speed of the lighting coverage region when rotating around the special effect starting point based on the lighting effect lighting information.

It can be known from the above embodiments that the user can custom-edit the related information of the lighting coverage region, including the region included angle and the rotation speed of the lighting coverage region, and the relative position of the special effect starting point around which the lighting coverage region rotates, thereby improving the custom design degree of the rotating chasing lighting effect, and enabling the user to custom-adjust the rotating chasing lighting effect that meets his/her individual requirements.

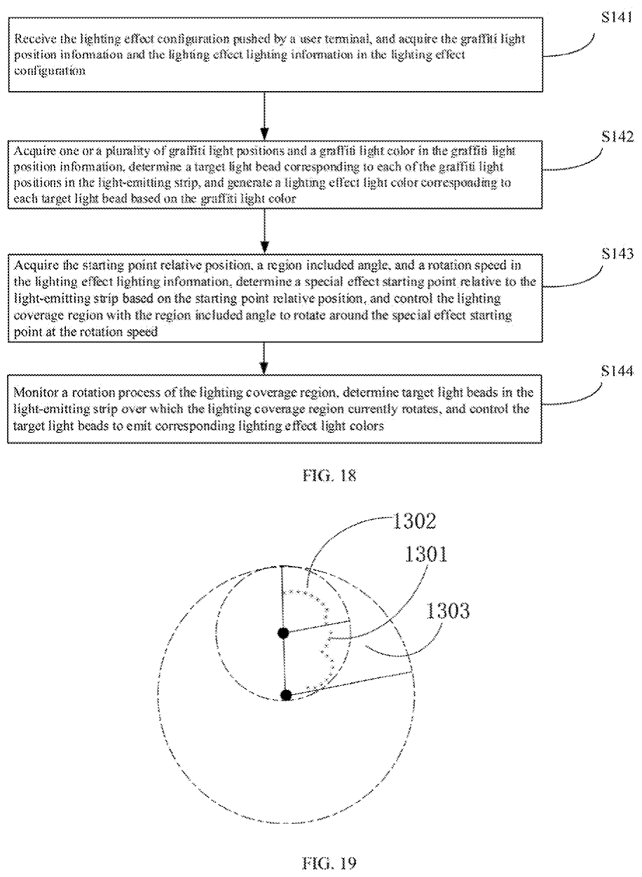

Based on any embodiment of the method of the present disclosure, referring to FIG. 18, pushing the lighting effect configuration to the light-emitting device of the light-emitting strip, includes:

In step S141, the lighting effect configuration pushed by a user terminal is received, and the graffiti light position information and the lighting effect lighting information in the lighting effect configuration are acquired.

After the light-emitting device receives the lighting effect configuration pushed by the user terminal, the controller of the light-emitting device acquires the graffiti light position information and the lighting effect lighting information in the lighting effect configuration.

In step S142, one or a plurality of graffiti light positions and a graffiti light color in the graffiti light position information are acquired, a target light bead corresponding to each of the graffiti light positions in the light-emitting strip is determined, and a lighting effect light color corresponding to each target light bead is generated based on the graffiti light color.

After acquiring the graffiti light position information in the lighting effect configuration, the controller acquires the graffiti light position and the graffiti light color thereof in the graffiti light position information. Then, based on the sorting position of the graffiti light position in the light strip model, the light bead corresponding to the sorting position in the light-emitting strip is correspondingly determined, and the light bead is used as the target light bead corresponding to the graffiti light position.

After the target light bead corresponding to the graffiti light position is determined, the lighting effect light color acting on the target light bead is generated based on the graffiti light color corresponding to the graffiti light position. For example, if the graffiti corresponding to the graffiti light position is red, the lighting effect light color of the target light bead corresponding to the graffiti light position is also red.

In step S143, the starting point relative position, a region included angle, and a rotation speed in the lighting effect lighting information are acquired, a special effect starting point relative to the light-emitting strip is determined based on the starting point relative position, and the lighting coverage region with the region included angle is controlled to rotate around the special effect starting point at the rotation speed.

When determining the target light bead corresponding to the graffiti light position in the light-emitting strip and generating the corresponding lighting effect light color, the controller also determines the special effect starting point and the lighting coverage region based on the lighting effect lighting information, so as to control the lighting coverage region to rotate around the special effect starting point.

After acquiring the starting point relative position in the lighting effect lighting information, the controller determines the special effect starting point relative to the light-emitting strip by a preset positioning method. Specifically, the following methods can be selected:

In one embodiment, the controller photographs the light-emitting strip by means of the camera unit connected thereto to acquire an image with the light-emitting strip, further identifies a plane position where the light-emitting strip is located in the image, and constructs a corresponding plane coordinate system in the image. The plane coordinate system corresponds to a plane coordinate system where a starting point on the interface canvas is located. For example, the origin of the plane coordinate system for the starting point on the interface canvas is located at the lower-left corner of the interface canvas, and a distance between the origin and the light strip model is determined to be pushed to the controller; the controller generates a corresponding origin in the image based on the distance to construct the plane coordinate system with the origin, and further determines a corresponding position in the plane coordinate system in the image based on plane coordinates represented by the starting point relative position, where the special effect starting point is generated at the position.

In another embodiment, the plane coordinate system used by the user terminal to position the starting point relative position corresponding to the starting point on the interface canvas is pushed by the light-emitting device to the user terminal in advance. After the starting point relative position of the light-emitting device is determined, the plane coordinate system pushed to the user terminal in advance is used to determine the corresponding position of the plane coordinate represented by the starting point relative position in the plane coordinate system, and then the special effect starting point is generated at the position.

After the controller determines the corresponding special effect starting point based on the starting point relative position in the lighting effect lighting information, a lighting coverage region with the region included angle is generated at the special effect starting point based on the region included angle of the starting point relative position, and the lighting coverage region is controlled to rotate around the special effect starting point based on the rotation speed in the lighting effect lighting information.

In step S144, the rotation process of the lighting coverage region is monitored, target light beads in the light-emitting strip over which the lighting coverage region currently rotates are determined, and the target light beads are controlled to emit corresponding lighting effect light colors.

The controller monitors the rotation process of the lighting coverage region around the special effect starting point in real time, and controls the target light beads to emit the corresponding lighting effect light colors after detecting that the lighting coverage region passes through the target light beads corresponding to the chasing positioning in the light-emitting strip.

It can be known from the above embodiments that based on the lighting effect configuration generated by the user by means of performing graffiti and dragging the starting point on the interface canvas, the light-emitting device determines light beads among the light-emitting light beads corresponding to the graffiti-defined graffiti light positions and their corresponding lighting effect colors, positions the special effect starting point corresponding to the starting point positioned by the user, and generates the lighting coverage region corresponding to the region included angle edited by the user. The lighting coverage region rotates around the special effect starting point, and then the light beads among the light-emitting light beads through which the lighting coverage region rotates are controlled to emit the lighting effect light color, so as to form the rotating chasing lighting effect corresponding to the custom-editing of the user, so that the emitted rotating chasing lighting effect can meet the personalized requirements of the user when using the light-emitting device, and improve the user's experience of using the light-emitting device.

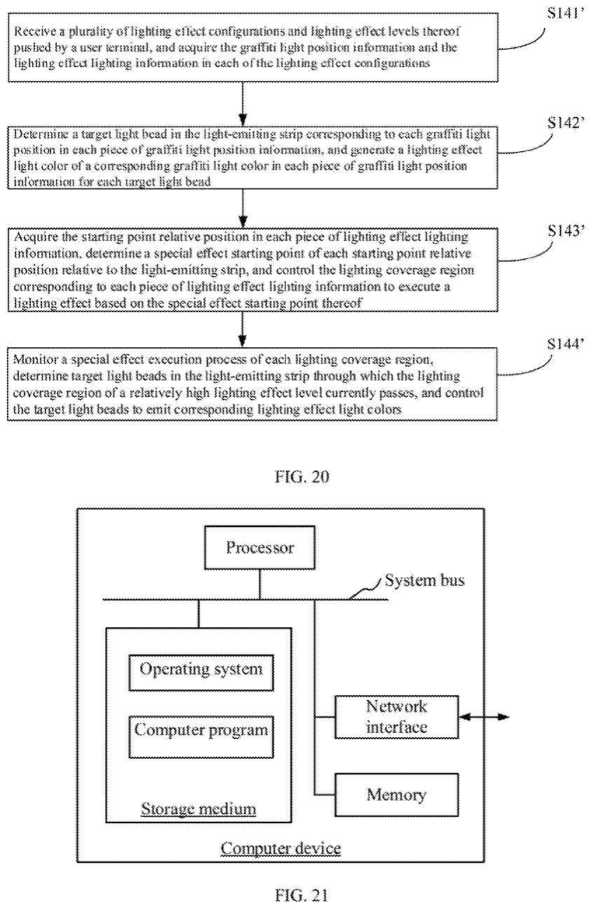

Based on any embodiment of the method of the present disclosure, referring to FIGS. 19 and 20, pushing the lighting effect configuration to the light-emitting device of the light-emitting strip, includes:

In step S141′, a plurality of lighting effect configurations and lighting effect levels thereof pushed by a user terminal are received, and the graffiti light position information and the lighting effect lighting information in each of the lighting effect configurations are acquired.

The user can design various lighting effect configurations and set the lighting effect levels for each lighting effect configuration to control the lighting priority of different lighting effect configurations. That is, for the lighting coverage region with a lighting effect configuration of a higher lighting effect level, the light beads in the lit light-emitting strip corresponding to the chasing positioning have a higher priority than those in the lighting coverage region with a lighting effect configuration of a lower lighting effect level. After the user terminal generates a plurality of lighting effect configurations and the user sets the lighting effect level for each lighting effect configuration, each lighting effect configuration and the lighting effect level thereof are pushed to the light-emitting device.

After the light-emitting device receives the plurality of lighting effect configurations and the lighting effect levels, the controller of the light-emitting device acquires the respective graffiti light position information and lighting effect lighting information in each lighting effect configuration to determine the target light bead corresponding to each lighting effect configuration, so as to generate the lighting coverage region with each lighting effect configuration to rotate.

In step S142′, a target light bead in the light-emitting strip corresponding to each graffiti light position in each piece of graffiti light position information is determined, and a lighting effect light color of a corresponding graffiti light color in each piece of graffiti light position information is generated for each target light bead.

After acquiring the graffiti light position information of the plurality of lighting effect configurations, the controller determines a target light bead in the light-emitting strip corresponding to each graffiti light position in each piece of graffiti light position information, and generates a lighting effect light color of a corresponding graffiti light color in each piece of graffiti light position information for each target light bead. Typically, the same light bead among the light-emitting light beads may be determined as the target light bead by a plurality of graffiti light positions, and in this case, the target light bead has a plurality of lighting effect light colors.

In step S143′, the starting point relative position in each piece of lighting effect lighting information is acquired, a special effect starting point of each starting point relative position relative to the light-emitting strip is determined, and the lighting coverage region corresponding to each piece of lighting effect lighting information is controlled to execute a lighting effect based on the special effect starting point thereof.

Taking the rotating chasing light effect as an example, after acquiring the lighting effect lighting information of each lighting effect configuration, the controller determines the special effect starting point corresponding to each lighting effect configuration based on the starting point relative position in each piece of lighting effect lighting information, then generates the lighting coverage region corresponding to each special effect starting point based on the region included angle in each piece of lighting effect lighting information, and then controls each lighting coverage region to rotate around the corresponding special effect starting point thereof based on the rotation speed in each piece of lighting effect lighting information.

In step S144′, the special effect execution process of each lighting coverage region is monitored, target light beads in the light-emitting strip through which the lighting coverage region of a relatively high lighting effect level currently passes are determined, and the target light beads are controlled to emit corresponding lighting effect light colors.

Taking the rotating chasing light effect as an example, referring to FIG. 19, as shown in FIG. 19, for the lighting effect configuration to which the shown lighting coverage region 1302 belongs, each graffiti light position in its graffiti light position information acts on all the light beads in the light-emitting strip 1301, and the corresponding lighting effect light color is red; for the lighting effect configuration to which the shown lighting coverage region 1303 belongs, each graffiti light position in its graffiti light position information also acts on all the light beads in the light-emitting strip 1301, and the corresponding lighting effect light color is blue; the lighting effect level corresponding to the shown lighting coverage region 1302 is higher than that of the shown lighting coverage region 1303. In this case, the rotation angle of the shown lighting coverage region 1302 is the same as the rotation angle of the shown lighting coverage region 1303, but the light beads in the light-emitting strip 1301 that are covered by both the shown lighting coverage region 1302 and the shown lighting coverage region 1303 only emit a lighting-effect light color in red, while the light beads in the light-emitting strip 1301 that are covered by the lighting coverage region 1303 and are not covered by the shown lighting coverage region 1302 emit a lighting-effect light color in blue.

It can be known from the above embodiments that the user can design a plurality of sets of different lighting effect configurations and set the lighting effect levels for each lighting effect configuration to control the light-emitting device to control the light-emitting strip to generate different lighting effects by combining the lighting effect configurations, so that the user can design different lighting effect configurations to enrich the lighting effect of the light-emitting strip and meet the personalized requirements of the user.

Based on any embodiment of the present disclosure, referring to FIG. 21, another embodiment of the present disclosure further provides a computer device. The computer device can function as a controller in the ambient light device. As shown in FIG. 21, a schematic diagram of an internal structure of the computer device is illustrated. The computer device includes a processor, a computer-readable storage medium, a memory, and a network interface, which are connected via a system bus. The computer-readable storage medium of the computer device stores an operating system, a database, and computer programs encapsulating computer-readable instructions. The database may store a control information sequence, and the computer-readable instructions, when executed by a processor, may cause the processor to implement a lighting effect projection playback method. The processor of the computer device is configured to provide computing and control capabilities, thereby supporting the operation of the entire computer device. The memory of the computer device may store one or more computer-readable instructions, and the one or more computer-readable instructions, when executed by the processor, cause the processor to perform the lighting effect projection playback method according to the present disclosure. The network interface of the computer device is configured to be connected to and communicate with a terminal. Those skilled in the art can understand that the structure shown in FIG. 21 is merely a block diagram of a part of the structure related to the solutions of the present disclosure, and does not constitute a limitation on the computer device to which the solutions of the present disclosure are applied. Specifically, the computer device may include more or fewer components than those shown in the figure, or combine some components, or have different component arrangements.

In this embodiment, the processor is configured to execute the specific functions of the above respective modules and submodules thereof, and the memory stores the program codes and various data required to execute the above modules or submodules. The network interface is configured to transmit data between user terminals or servers. The memory in this embodiment stores program codes and data required to execute all modules/submodules in the apparatus for playing lighting effect projections according to the present disclosure, and the server can call the program codes and data of the server to execute the functions of all submodules.

The present disclosure further provides a non-volatile computer-readable storage medium. One or more computer-readable instructions, when executed by one or more processors, cause the one or more processors to perform the steps of the method according to any one of the embodiments of the present disclosure.

The present disclosure further provides a computer program product including one or more computer programs/instructions. The one or more computer programs/instructions, when executed by one or more processors, cause the one or more processors to perform the steps of the method according to any one of the embodiments of the present disclosure.

In summary, in the present disclosure, since the planar region occupied by the determined display control window is substantially similar, when the target lighting effect is played accordingly, the difference in the density of the light-emitting units in different regions caused by the bending and folding of the light-emitting strip can be effectively balanced, so that unnecessary distortion of the played lighting effect relative to the desired effect can be effectively prevented, and the display of the lighting effects is more accurate, which can improve the user's product experience and make it easier to promote and popularize such ambient light devices. In addition, the chasing lighting effect editing functionality provided by the present disclosure not only offers the user a convenient, intuitive, and clear human-machine interaction logic to enhance the lighting effect editing efficiency of the user, but also enables highly customized lighting effects of the light-emitting device for the user, allowing the user to custom-adjust lighting effects to meet his/her individual requirements and meet the personalized requirements of the user when using the light-emitting device.

The above description only relates to some embodiments of the present disclosure, and is not intended to limit the patent scope of the present disclosure. Any equivalent structural transformations made on the basis of the content of this specification and drawings or any direct/indirect applications in other related technical fields under the technical concept of the present disclosure shall all fall within the scope of patent protection of the present disclosure.

What is claimed is:

1. A lighting effect projection playback method, comprising:
acquiring a position information stream corresponding to light-emitting units in a light-emitting strip, the position information stream comprising position distribution information corresponding to each of the light-emitting units in the light-emitting strip;
unfolding to obtain a light strip projection map in a preset coordinate system based on the position distribution information of each of the light-emitting units, so as to reconstruct the light-emitting strip and pattern data of each of the light-emitting units therein in the light strip projection map;
dividing the light-emitting strip in the light strip projection map into a plurality of light-emitting unit sets by using a region tolerance window to correspondingly form a plurality of display control windows; and
generating, with each display control window as a batch control unit, light-emitting control data corresponding to a target lighting effect for the light-emitting unit set of each display control window, and controlling the light-emitting strip to play the target lighting effect based on the light-emitting control data.

2. The lighting effect projection playback method according to claim 1, wherein dividing the light-emitting strip in the light strip projection map into the plurality of light-emitting unit sets by using the region tolerance window to correspondingly form the plurality of display control windows, comprises:
acquiring a dimension specification of the region tolerance window, and moving, with one end of the light-emitting strip in the light strip projection map as a starting end, the region tolerance window along the light-emitting strip to the other end;
determining, during movement of the region tolerance window, the light-emitting units that fall within the region tolerance window and are not incorporated into other display control windows, and considering, when a maximum number of the light-emitting units that are capable of being covered by the region tolerance window is reached, that the display control window is detected;
establishing, when the display control window is detected, mapping relationship data between the display control window and the light-emitting unit set composed of the light-emitting units corresponding to the display control window; and
upon completing construction of the mapping relationship data for one display control window, continuing to slide the region tolerance window for the above iteration until a last light-emitting unit is incorporated into a corresponding display control window.

3. The lighting effect projection playback method according to claim 2, wherein acquiring the dimension specification of the region tolerance window, comprises:
counting a total number of the light-emitting units in the light strip projection map, and calculating an average value of the total number of the light-emitting units based on a number of zones to obtain an average number of the light-emitting units;
zoning all the light-emitting units in the light strip projection map based on the average number of the light-emitting units to determine a coverage window corresponding to each zone;
separately calculating an average transverse dimension and an average longitudinal dimension based on a transverse dimension and a longitudinal dimension of the coverage window of each zone; and
setting the average transverse dimension and the average longitudinal dimension as the dimension specification of the region tolerance window.

4. The lighting effect projection playback method according to claim 1, wherein dividing the light-emitting strip in the light strip projection map into the plurality of light-emitting unit sets by using the region tolerance window to correspondingly form the plurality of display control windows, comprises:
acquiring a coordinate reference point of the coordinate system and a preset increment dimension, searching for the light-emitting unit closest to the coordinate reference point based on the light strip projection map, and taking a region with the coordinate reference point as a center of a circle and a distance from the coordinate reference point to the light-emitting unit as a radius as an empty region;
adding the increment dimension to the radius to obtain a new radius, determining an annular region between the previous radius and the new radius, and taking the annular region as the region tolerance window; and
taking, when the light-emitting units are present in the region tolerance window, the region tolerance window as the display control window, taking all the light-emitting units in the region tolerance window as the light-emitting unit set corresponding to the display control window, establishing mapping relationship data between the display control window and the light-emitting unit set, and iterating the previous step until a corresponding region tolerance window no longer comprises the light-emitting units.

5. The lighting effect projection playback method according to claim 1, wherein generating, with each display control window as the batch control unit, the light-emitting control data corresponding to the target lighting effect for the light-emitting unit set of each display control window, comprises:
calling lighting effect description data of the target lighting effect, the lighting effect description data comprising motion information and lighting effect color data;
determining a playback time slot of each of the display control windows based on the motion information;
determining color data of each display control window based on the lighting effect color data; and
setting, based on the playback time slot and the color data of each display control window, the light-emitting control data corresponding to the display control window as light-emitting control data of each light-emitting unit in the light-emitting unit set of the display control window.

6. The lighting effect projection playback method according to claim 5, wherein controlling the light-emitting strip to play the target lighting effect based on the light-emitting control data, comprises:
transmitting, in the playback time slot corresponding to each display control window, the light-emitting control data corresponding to the display control window to the light-emitting strip as the light-emitting control data of each of the light-emitting units corresponding to the display control window; and
playing, by each of the light-emitting units in the light-emitting strip corresponding to the display control window, corresponding lighting effects based on the light-emitting control data.

7. A method for editing a lighting effect light-emitting region, comprising:
determining a shape path of a light-emitting strip and a plurality of light positions on the shape path based on a light strip image to construct a corresponding light strip model and display the light strip model on an interface canvas;
determining, in response to a light position graffiti event, the light positions in the light strip model where graffiti is performed as graffiti light positions, and generating corresponding graffiti light position information;
determining, in response to a starting point positioning event, a position of a starting point on the interface canvas as a starting point relative position, and generating corresponding lighting effect lighting information, wherein the starting point is configured to position a special effect starting point of a lighting coverage region, and the lighting coverage region is configured to activate a light effect of the graffiti light positions; and
generating, in response to a lighting effect application event, a lighting effect configuration with the graffiti light position information and the lighting effect lighting information, and pushing the lighting effect configuration to a light-emitting device of the light-emitting strip.

8. The method for editing a lighting effect light-emitting region according to claim 7, wherein determining the shape path of the light-emitting strip and the plurality of light positions on the shape path based on the light strip image to construct the corresponding light strip model and display the light strip model on the interface canvas, comprises:
acquiring the light strip image generated by a camera unit photographing the light-emitting strip in a lit state, determining a shape region of the light-emitting strip in the light strip image to define the shape path of the light-emitting strip, and extracting a light strip body image in the shape region;
identifying salient lighting features in the light strip body image, and determining positions where each salient lighting feature is located as corresponding light positions;
converting the shape path into a vector curve, and adding, corresponding to a position of each of the light positions on the shape path, a visual identifier corresponding to each light position at a corresponding position on the vector curve; and
drawing the vector curve and the visual identifier onto the interface canvas to form the light strip model, and then rendering and displaying the light strip model.

9. The method for editing a lighting effect light-emitting region according to claim 8, wherein determining, in response to the light position graffiti event, the light positions in the light strip model where graffiti is performed as the graffiti light positions, and generating the corresponding graffiti light position information, comprises:
acquiring a graffiti light color edited by a user, and generating a graffiti brush corresponding to the graffiti light color;
determining, in response to a graffiti drawing event, a graffiti path of the graffiti brush on the interface canvas;
taking one or a plurality of light positions through which the graffiti path passes in the light strip model as the graffiti light positions, and modifying a light position color of each of the graffiti light positions to the graffiti light color; and
generating the graffiti light position information with each of the graffiti light positions and the graffiti light color.

10. The method for editing a lighting effect light-emitting region according to claim 8, wherein determining, in response to the starting point positioning event, the position of the starting point on the interface canvas as the starting point relative position, and generating the corresponding lighting effect lighting information, wherein the starting point is configured to position the special effect starting point of the lighting coverage region, and the lighting coverage region is configured to activate the light effect of the graffiti light positions, comprises:
adjusting a region included angle of the lighting coverage region based on a lighting effect lighting coverage angle edited by a user;
adjusting a rotation speed of the lighting coverage region during rotation based on a user-edited rotation speed;
determining, in response to a starting point dragging event, a position where the starting point is dragged on the interface canvas as the starting point relative position; and
generating the lighting effect lighting information with the region included angle and the rotation speed of the lighting coverage region, and the starting point relative position.

11. The method for editing a lighting effect light-emitting region according to claim 8, wherein pushing the lighting effect configuration to the light-emitting device of the light-emitting strip, comprises:
receiving the lighting effect configuration pushed by a user terminal, and acquiring the graffiti light position information and the lighting effect lighting information in the lighting effect configuration;
acquiring one or a plurality of graffiti light positions and a graffiti light color in the graffiti light position information, determining a target light bead corresponding to each of the graffiti light positions in the light-emitting strip, and generating a lighting effect light color corresponding to each target light bead based on the graffiti light color;
acquiring the starting point relative position, a region included angle, and a rotation speed in the lighting effect lighting information, determining a special effect starting point relative to the light-emitting strip based on the starting point relative position, and controlling the lighting coverage region with the region included angle to rotate around the special effect starting point at the rotation speed; and
monitoring a rotation process of the lighting coverage region, determining target light beads in the light-emitting strip over which the lighting coverage region currently rotates, and controlling the target light beads to emit corresponding lighting effect light colors.

12. The method for editing a lighting effect light-emitting region according to claim 8, wherein pushing the lighting effect configuration to the light-emitting device of the light-emitting strip, comprises:
receiving a plurality of lighting effect configurations and lighting effect levels thereof pushed by a user terminal, and acquiring the graffiti light position information and the lighting effect lighting information in each of the lighting effect configurations;
determining a target light bead in the light-emitting strip corresponding to each graffiti light position in each piece of graffiti light position information, and generating a lighting effect light color of a corresponding graffiti light color in each piece of graffiti light position information for each target light bead;
acquiring the starting point relative position in each piece of lighting effect lighting information, determining a special effect starting point of each starting point relative position relative to the light-emitting strip, and controlling the lighting coverage region corresponding to each piece of lighting effect lighting information to execute a lighting effect based on the special effect starting point thereof; and
monitoring a special effect execution process of each lighting coverage region, determining target light beads in the light-emitting strip through which the lighting coverage region of a relatively high lighting effect level currently passes, and controlling the target light beads to emit corresponding lighting effect light colors.

13. An ambient light device, comprising a controller and at least one light-emitting strip, wherein the controller is configured to perform at least one of a lighting effect projection playback method and a method for editing a lighting effect light-emitting region,
wherein the lighting effect projection playback method comprises:
acquiring a position information stream corresponding to light-emitting units in a light-emitting strip, the position information stream comprising position distribution information corresponding to each of the light-emitting units in the light-emitting strip;
unfolding to obtain a light strip projection map in a preset coordinate system based on the position distribution information of each of the light-emitting units, so as to reconstruct the light-emitting strip and pattern data of each of the light-emitting units therein in the light strip projection map;
dividing the light-emitting strip in the light strip projection map into a plurality of light-emitting unit sets by using a region tolerance window to correspondingly form a plurality of display control windows; and
generating, with each display control window as a batch control unit, light-emitting control data corresponding to a target lighting effect for the light-emitting unit set of each display control window, and controlling the light-emitting strip to play the target lighting effect based on the light-emitting control data; and
wherein the method for editing a lighting effect light-emitting region comprises:
determining a shape path of a light-emitting strip and a plurality of light positions on the shape path based on a light strip image to construct a corresponding light strip model and display the light strip model on an interface canvas;
determining, in response to a light position graffiti event, the light positions in the light strip model where graffiti is performed as graffiti light positions, and generating corresponding graffiti light position information;
determining, in response to a starting point positioning event, a position of a starting point on the interface canvas as a starting point relative position, and generating corresponding lighting effect lighting information, wherein the starting point is configured to position a special effect starting point of a lighting coverage region, and the lighting coverage region is configured to activate a light effect of the graffiti light positions; and
generating, in response to a lighting effect application event, a lighting effect configuration with the graffiti light position information and the lighting effect lighting information, and pushing the lighting effect configuration to a light-emitting device of the light-emitting strip.
